(19) United States
(12) Patent Application Publication
(10) Pub. No.: US 2011/0055219 A1
(43) Pub. Date: Mar. 3, 2011

(54) DATABASE MANAGEMENT DEVICE AND METHOD

(75) Inventors: Hiroshi YAMAMOTO, Nagaoka (JP); Shigeki FUKUTA, Kawasaki (JP); Kazuo SASAKI, Kawasaki (JP)

(73) Assignee: FUJITSU LIMITED, Kawasaki-shi (JP)

(21) Appl. No.: 12/872,269

(22) Filed: Aug. 31, 2010

(30) Foreign Application Priority Data
Sep. 1, 2009 (JP) 2009-201468

(51) Int. Cl. G06F 17/30

(52) U.S. Cl. 707/741; 707/E17.002; 707/E17.005

(57) ABSTRACT

A database system includes a database device for managing a database including data records, each data record including identification information and an attribute value, index devices for managing an index database including index records, each index record including search information determined by the attribute value and the identification information, each index devices managing each of parts of the index database, and a management device executing a process including detecting an update frequency of the attribute value stored in the database, generating search information by combining the attribute values, each attribute values having the update frequency higher than a predetermined frequency, generating the index record including the generated search information and the identification information associated with the combined attribute values included in the generated search condition information, and determining one of the plurality of index devices for managing the generated index record.

### CROSS-REFERENCE TO RELATED APPLICATION

This application is based upon and claims the benefit of priority of the prior Japanese Patent Application No. 2009-201468, filed on Sep. 1, 2009 the entire contents of which are incorporated herein by reference.

### FIELD

The embodiment discussed herein is related to a database management device and method.

### BACKGROUND

A database system includes multiple databases for storing data in a distributed manner and multiple index management devices for storing index information, used for searching the databases, in a distributed manner. The databases manages actual data by using identification information as key information, and also store attribute items and attribute values of pieces of attribute information corresponding to the identification information. Each index management device uses an attribute value in the attribute information as key information to store, as index information, identification information having the attribute value. The index management devices divide a management range of the index information and manage the divided management ranges.

In the database system, when an attribute value changes, identification information is registered in an index corresponding to the changed attribute value and identification information is deleted from an index corresponding to the pre-change attribute value. Thus, when indexes after and before a change in the attribute value are managed by different index management devices, the index management device having the index of the pre-change attribute value deletes identification information and the index management device having the index of the changed attribute value registers identification information. Since communication for processing for registering information from the database to the index management devices and deleting information occurs, there is a problem in that load arises in the database system.

Examples of related art includes Japanese Laid-open Patent Publication Nos. 2006-197400, 2005-332026, 2008-233966, and 2007-18415.

### SUMMARY

According to an aspect of the invention, a management device of a database system including a database device for managing a database including data records, each of the data records including identification information for identifying the data records and an attribute value, a plurality of index devices for managing an index database including index records, each of the index records including search condition information and the identification information, the search condition information being determined by the attribute value, each of the plurality of index devices managing each of parts of the index database, the management device includes a receiver for receiving an update of the attribute value from the database device, a processor for executing a process including detecting a frequency of update of the attribute value stored in the database device, generating search condition information by combining the attribute values, each of the attribute values having the frequency of update higher than a predetermined frequency, generating the index record including the generated search condition information and the identification information associated with one of the combined attribute values included in the generated search condition information, and determining one of the plurality of index devices for managing the generated index record.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates one example of a database system;

FIG. 2 illustrates a database stored on database devices;

FIG. 3 illustrates index information;

FIG. 4 is a block diagram of an index management device;

FIG. 5 illustrates an example of index-information distributed management performed by the index management devices;

FIG. 6 is a functional block diagram of the index management device;

FIG. 7 is a flowchart of index-information update processing executed by each index management device;

FIG. 8 illustrates an example of update-search count information;

FIG. 9 is a flowchart of processing for searching the index information;

FIG. 10 is a flowchart of processing for determining an update frequency;

FIG. 11 illustrates an example of a frequency-information database;

FIG. 12 illustrates an example of a representative frequency-information database;

FIG. 13 illustrates an example of a delegation frequency-information database;

FIG. 14 illustrates an example of a state in which the index management devices manage frequency information;

FIG. 15 is a flowchart of frequency-information report processing;

FIG. 16 is a flowchart of frequency-information reception processing;

FIG. 17 is a flowchart of frequency-information search processing;

FIG. 18 illustrates an example of collective management performed by the index management device;

FIG. 19 is a flowchart of processing for determining index entries for the collective management on the basis of the frequency information;

FIG. 20 is a flowchart of processing for terminating the collective management or dividing the range;

FIG. 21 illustrates an example of distributed management performed by the index management device;

FIGS. 22 and 23 are flowcharts illustrating application of distributed management processing;

FIG. 24 is a flowchart of termination of the distributed management processing;

FIGS. 25 and 26 are flowcharts of the processing for transmitting the identification information; and

FIG. 27 is a flowchart of processing for receiving the identification information.

### DESCRIPTION OF EMBODIMENT

A database system according to one embodiment will be described below with reference to the accompanying drawings.

[Database System]

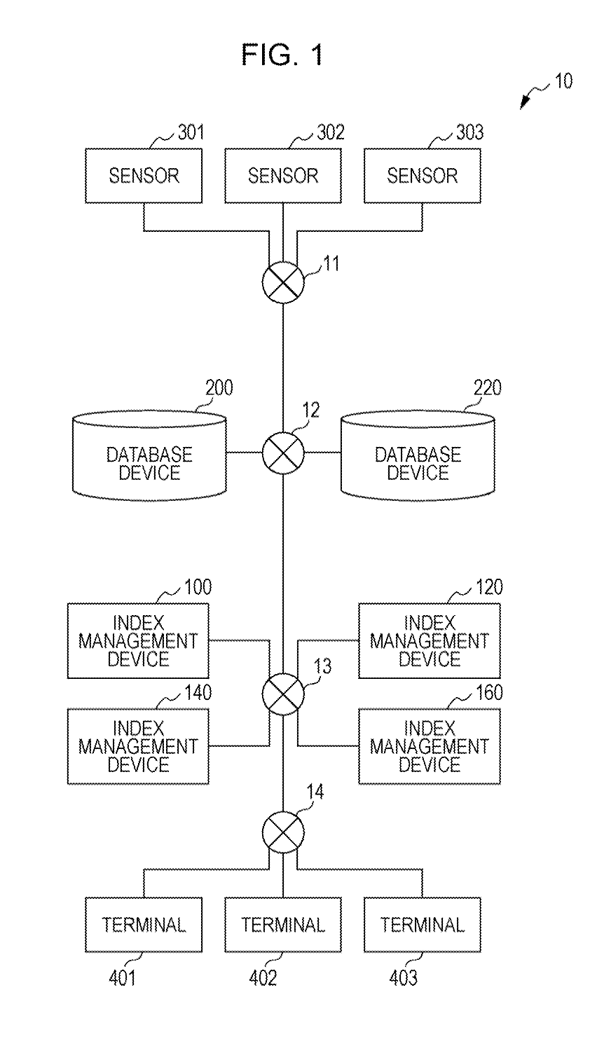

FIG. 1 illustrates one example of a database system.

As illustrated in FIG. 1, a database system 10 includes multiple index management devices 100, 120, 140, and 160 for managing index information, multiple database devices 200 and 220 for managing databases, multiple sensors 301, 302, and 303 for obtaining data, and multiple terminals 401, 402, and 403 for searching for data in the databases. Reference numerals 11, 12, 13, and 14 indicate networks. The networks may be constituted by a single network or may be physically separated networks, for example, the Internet and intranets.

The database devices 200 and 220 store data records. The data records include identification information in databases in association with attribute information corresponding thereto, by using the identification information as key information. The index management device (index device) 100 manages index information that includes the attribute information and a collection of identification information, by using attribute information as key information. Each index management device has a connection unit, a detection unit, a reception unit, and an execution unit. The connection unit can connect to the database and another index management device. The detection unit detects a frequency of update of the attribute information associated with the identification information in the database. The reception unit receives a result of the detection from another index management device. The execution unit determines whether or not sets of pieces of attribute information are to be combined, on the basis of the update frequencies. The execution unit further determines the index information of the combined set of the attribute information, determines an index management device for managing the determined index information, and transmits a request for managing the determined index information to the determined index management device. In accordance with the update frequencies of the attribute values, the index management device 100 performs processing for setting the index entries in each of the index management devices 100, 120, 140, and 160 so that the management can be performed in the range of the attribute values. Combining multiple attribute values to create an index entry for the range of the attribute values and managing the index entry is herein referred to as “collective management”. Dividing the collectively managed index entry and managing the divided index entries will hereinafter be referred to as “distributed management”.

Processing for applying or terminating the distributed management for dividing a collectively managed index entry into multiple index entries and managing the divided index entries is performed in accordance with the amount of load of each of the index management devices 100, 120, 140, and 160. As a result, the database system 10 can perform autonomous distributed management of the index information. Consequently, the index management device 100 can perform processing for applying the collective management in which attribute values that are frequently updated are gathered in one index management device and processing for applying the distributed management only when the amount of load concentrates on a particular index management device.

[Sensors]

The sensors 301, 302, and 303 have sensor functions for detecting attribute information to be managed by the database system 10. Examples of the attribute information detected by the sensors 301, 302, and 303 include attribute values, for example, a humidity=50%, a temperature=28° C., and a place=office A, which correspond to respective attribute items (data items), such as a humidity, a temperature, and a place. The sensors may be RFID (radio frequency identification) sensors. Each sensor in the present embodiment has identification information. Each sensor can connect to the database device 200 or 220 through the network 11.

[Database Devices]

The database device 200 or 220 obtains the identification information of the sensor 301, 302, or 303 and the detected attribute information in conjunction with each other. Each of the sensors 301, 302, and 303 may have a function for transmitting information detected by the sensor to the database device 200 or 220 through the network 11.

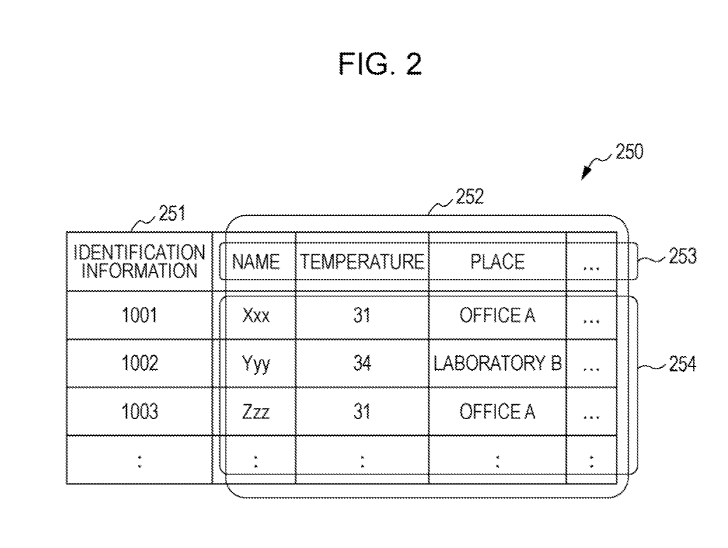

The database devices 200 and 220 manage the databases. FIG. 2 illustrates a database 250 stored on the database devices 200 and 220. The database 250 has identification information 251 and attribute information 252. The database 250 has a data structure in which pieces of attribute information 252 are associated with corresponding pieces of identification information 251 by using the identification information 251 as key information. The identification information 251 is information for identifying information bodies (entities or content to be stored). Examples of the entities include people, objects, and places. For example, when one piece of identification information 251 has a temperature and a position, a temperature sensor and a position-detecting sensor correspond to the piece of identification information 251. One sensor that is capable of detecting both a temperature and a position may also correspond to one piece of identification information 251. The attribute information 252 is information with which the states of the entities can be identified. When multiple pieces of attribute information 252 associated with one entity are gathered, the entity can be distinguished from another entity. The attribute information 252 has attribute items 253 specifying attribute types and attribute values 254 specifying the states of the attribute items 253. The attribute items 253 are, for example, a name, a temperature, and a place. For example, when the attribute item 253 is a temperature, the attribute value 254 indicates a temperature of 28° C. or the like. When the attribute item 253 is a place, the attribute value 254 represents an address or the like.

The database devices 200 and 220 store the databases in a distributed manner. For example, the database device 200 stores, in the database 250, identification information 251 with numbers 0 to 1000 and the database device 220 stores, in the database 250 managed thereby, identification information 251 with numbers 1001 to 2000. The distributed databases 250 for storage make it possible to distribute the amount of load of processing, which includes addition/deletion of the identification information or the attribute information to/from the databases 250, to the multiple database devices 200 and 220. With respect to the database devices 200 and 220, the sensors whose data are to be stored are predetermined. When a sensor is dynamically added or deleted, sensors whose data are to be recorded are dynamically re-defined. The database devices 200 and 220 obtain the identification information 251, the attribute items 253, and the attribute values 254 from the sensors whose data are to be stored in the databases 250. The database devices 200 and 220 can connect to each other through the network 12.

A description will now be given of an overview of data storage processing performed by the database device 200. The database device 200 identifies a data storage area in the database 250 on the basis of the identification information 251 and the attribute item 253 received from the sensor whose data is to be stored. The database device 200 stores, in the identified data storage area, the attribute values 254 received from the sensor whose data is to be stored. Since the data storage processing at the database device 220 can be realized by a method that is similar to the method for the data storage processing at the database device 200, a description thereof is not given hereinbelow.

The database devices 200 and 220 connect to the index management devices 100, 120, 140, and 160 through the network 12. In this case, the database devices 200 and 220 may connect to one of the index management devices 100, 120, 140, and 160. The database devices 200 and 220 transmit database update information to one of the index management devices 100, 120, 140, and 160. The database devices 200 and 220 transmit the update information, for example, each time the data in the database is updated.

[Terminals]

The terminals 401, 402, and 403 are devices for issuing requests for searching for information stored in the databases 250. Each of the terminals 401, 402, and 403 may be a terminal device operated by a user who desires to obtain information in the databases 250 or may be a server device used by many terminal devices. Each of the terminals 401, 402, 403 connects to one of the index management devices 100, 120, 140, and 160 through the network 14.

[Index Management Devices]

The index management devices 100, 120, 140, and 160 manage the index information (indices) in the databases 250 in the database devices 200 and 220. Each of the index management devices 100, 120, 140, and 160 connects to the other index management devices, the database devices 200 and 220, and the terminals 401, 402, and 403 through the network 13.

[Index Information]

A description will now be given of the index information managed by each of the index management devices 100, 120, 140, and 160. Each of the index management devices 100, 120, 140, and 160 manages the index information in a predetermined range. A description will now be given of index information 500 managed by the index management device 100.

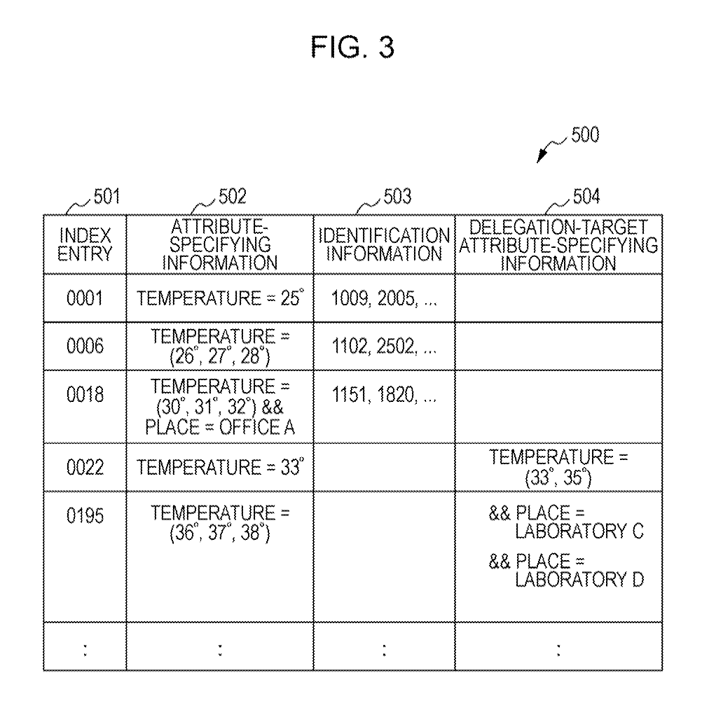

FIG. 3 illustrates the index information (index database) 500. The index information 500 has index entries 501 and identification information 503. The index entry 501 is an area that stores information for identifying attribute information on the basis of the attribute items 253 and the attribute values 254 in the attribute information 252 in the database 250. Attribute-specifying information (search condition information) 502 in the index information 500 is an area that stores the state of an attribute identified by the attribute item 253 and the attribute value 254 in the databases 250. The attribute-specifying information (search condition information) 502 may be determined by the attribute value and the item. The identification information 503 is an area that stores the identification information 251 in the database 250, the identification information 251 having the attribute-specifying information 502 in the index information 500. The identification information 503 may be associated with the attribute value and the item stored in the database 250. Delegation-target attribute-specifying information 504 is an area used when the index management device delegates the management of the index entry 501 to another index management device included in the database system 10. The delegation-target attribute-specifying information 504 stores attribute-specifying information of a delegation-target. For example, for the index entry 501 “0001” in FIG. 3, the attribute-specifying information 502 indicates an attribute value “25° C.” for the attribute item “temperature” and the identification information 503 having the attribute-specifying information 502 “25° C.” indicates “1009” and “2005”.

For searching for an entity having one feature, a search condition is an attribute value corresponding to one attribute item and a search result is identification information corresponding to the entity. When the index management devices 100, 120, 140, and 160 in the database system 10 search the index information in order to manage the index information, it is possible to locate the identification information having the attribute information. Thus, even when the database is stored in a distributed manner, it is possible to quickly identify the identification information having the attribute information. Since the identification information is distributed, the amount of load of the search processing can be distributed to the multiple index management devices even when the amount of the search request is large. The index management device 100 may manage the attribute-specifying information 502 obtained by combination of multiple pieces of attribute information 252.

For example, for the attribute-specifying information 502 corresponding to the index entry 501 “0006”, the attribute value of the attribute item “temperature” is 26°, 27°, or 28°. The index management device 100 stores, in the identification information 503, the identification information 251 having any of the attribute values 254 “26°”, “27°”, and “28°” for the attribute item 253 “temperature” in the database 250, in association with the index entry 501 “0006”. For the attribute-specifying information 502 corresponding to the index entry 501 “0018”, the attribute value of the attribute item “temperature” is “30°, 31°, or 32°” and the attribute value of the attribute item “place” is “Office A”. The index management device 100 stores, in the identification information 503, the identification information 251 having any of the attribute values 254 “30°”, “31°”, and “32°” for the attribute item 253 “temperature” in the database 250 and the attribute value 254 “Office A” for the attribute item 253 “place”, in association with the index entry 501 “0018”.

For the attribute-specifying information 502 corresponding to the index entry 501 “0022”, the attribute value of the attribute item “temperature” is 33°. The management of the index entry 501 “0022” is delegated. The delegation-target attribute-specifying information 504 has an attribute item “temperature” and an attribute value in the range of 33° or 35°. When a request for searching for the index entry 501 “0022” is received, the index management device 100 identifies a delegation-target index management device on the basis of the delegation-target attribute-specifying information 504 and transfers the search request to the delegation-target.

The attribute-specifying information 502 corresponding to the index entry 501 “0195” indicates that the attribute value of the attribute item “temperature” is “36°, 37°, or 38°”. The index entry 501 “0195” is divided for two delegation-target index management devices for delegation. Two entries of delegation-target attribute-specifying information are stored in the delegation-target attribute-specifying information 504. For one entry of the delegation-target attribute-specifying information, the attribute value of the attribute item “temperature” is “36°, 37°, or 38°” and the attribute value of the attribute item “place” is “Laboratory C”. For the attribute-specifying information of the other delegation-target, the attribute value of the attribute item “temperature” is in the range of “36°, 37°, and 38°” and the attribute value of the attribute item “place” is “Laboratory D”.

Upon receiving a search request for the index entry 501 “0195”, the index management device 100 identifies the delegation-target index management devices on the basis of the delegation-target attribute-specifying information 504 and transfers the search request to the delegation-target index management devices. Upon receiving a search request that does not include the attribute information “place” and that corresponds to the index entry 501 “0195”, the index management device 100 identifies the delegation-target index management devices on the basis of the delegation-target attribute-specifying information 504 and transfers the search request to both of the delegation-target index management devices.

[Distributed Management of Index Information]

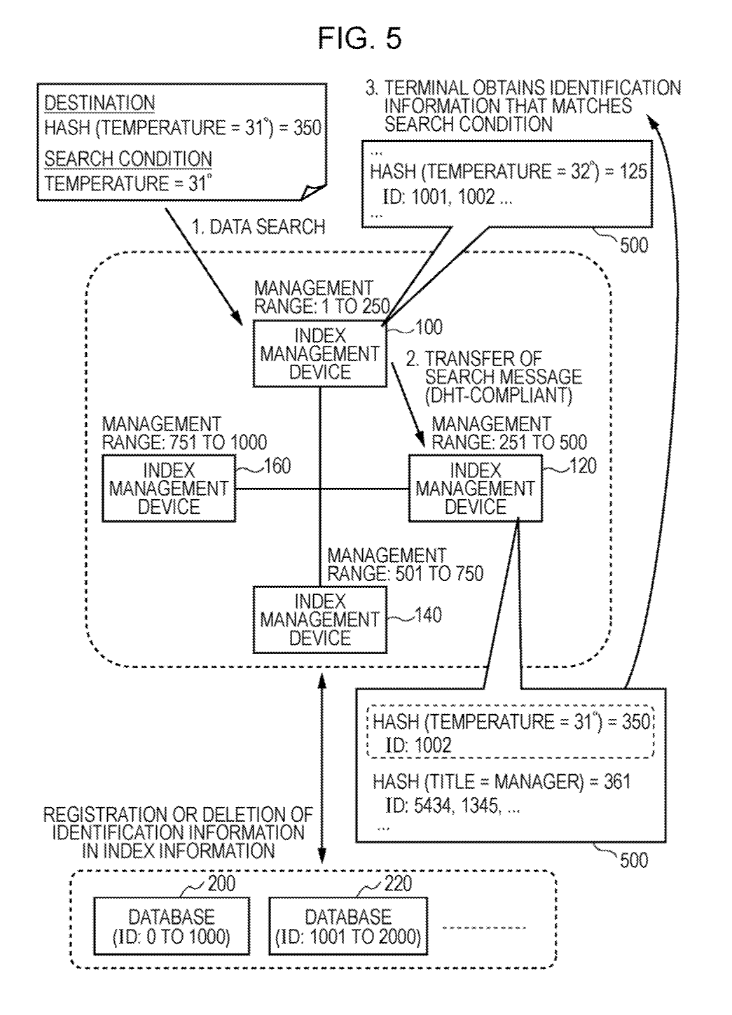

In the present embodiment, the index management devices 100, 120, 140, and 160 manage the index information in a distributed manner. FIG. 5 illustrates an example of index-information distributed management performed by the index management devices. Since the index entries 501 exist for respective pieces of the attribute-specifying information 502, the number of index entries 501 is significantly large. Accordingly, in the database system 10, the multiple index management devices manage the index information in a distributed manner. For example, each of the index management devices 100, 120, 140, and 160 employs a distributed hash table technology to manage the index information in a distributed manner. The index entries 501 may be hash values for the attribute-specifying information 502. The use of the distributed hash table technology makes it easy to deal with system changes in the database system 10. Examples of the system changes include increases/decreases in the number of terminals, the number of sensors, the number of pieces of identification information (entities), and the number of types of attribute information.

Each index management device uses a hash function, predetermined for the database system 10, to determine a hash value resulting from a combination of the attribute item 253 and the attribute value 254. For example, the hash value “0001” of the index entry 501 in FIG. 3 is a value determined by a hash function on the basis of the attribute-specifying information 502 indicating the attribute value “25°” of the attribute item “temperature”. A hash value for a certain attribute value is not necessarily adjacent to a hash value for an attribute value that is adjacent to the certain attribute value. In some attribute items (in particular, entries in which the attribute values are continuous values), attribute values having high update frequencies are in many cases adjacent to each other (for example, the temperature is frequently updated among 24°, 25°, and 26°). The possibility that a set of pieces of attribute information having high update frequencies is managed by different index management devices is higher in a case in which the distributed hash table technology is used than a case in which the index information is managed in a distributed manner without use of the distributed hash table technology.

The index management devices 100, 120, 140, and 160 store the index information in a distributed manner. The range of the index-information management performed by each index management device is determined by, for example, dividing the number of types of key information in the index information by the number of index management devices included in the database system 10. For example, it is assumed that the number of index management devices included in the database system 10 is 4 and the number of index entries is 1000. In this case, each index management device manages 250 index entries. More specifically, the index management device 100 stores, in the index information, index entries with numbers 1 to 250; the index management device 120 stores, in the index information, index entries with numbers 251 to 500; the index management device 140 stores, in the index information, index entries with numbers 501 to 750; and the index management device 160 stores, in the index information, index entries with numbers 751 to 1000. The index management devices 100, 120, 140, and 160 compute the attribute-specifying information 502 by using a hash function, use a resulting hash value as the index entry 501, and determine the index management device that manages the index entry 501 on the basis of the value of the index entry 501.

[Block Diagram of Index Management Device]

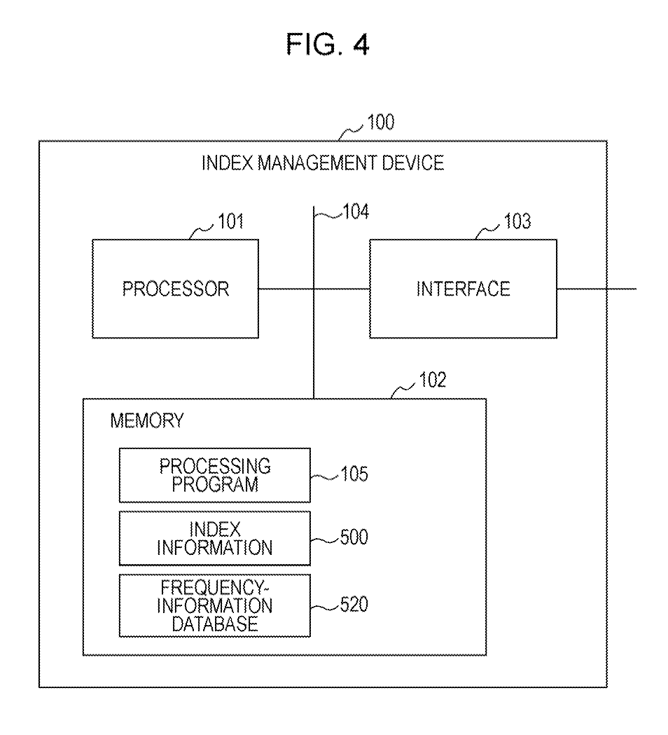

FIG. 4 is a block diagram of the index management device 100. Since the other index management devices 120, 140, and 160 in the database system 10 have configurations that are similar to that of the index management device 100, descriptions thereof are not given hereinafter.

The index management device 100 includes a processor 101, a memory 102, and an interface 103. The processor 101, the memory 102, and the interface 103 are connected through a bus 104. The processor 101 executes processing, such as management of the index information 500, in accordance with a processing program 105 stored in the memory 102. The processor 101 may executes a process including detecting a frequency of update of the attribute value stored in the database device, generating search condition information by combining the attribute values, each of the attribute values has the frequency of update higher than a predetermined frequency, generating the index record including the generated search condition information and the identification information associated with one of the combined attribute values included in the generated search condition information, and determining one of the plurality of index devices for managing the generated index record. The memory 102 temporarily stores, for example, the processing program 105 and temporary data for processing executed by the processor 101. The memory 102 also stores the index information 500 and the frequency information database 520. The interface 103 connects to the network 13 to transmit/receive data.

[Functional Block Diagram of Index Management Device]

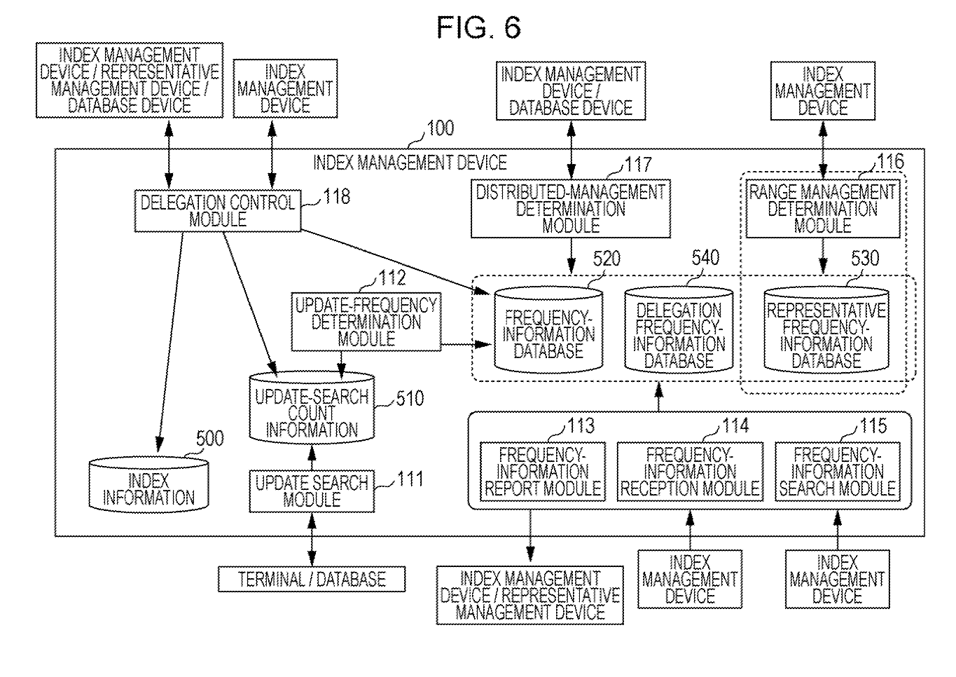

FIG. 6 is a functional block diagram of the index management device 100. The processor 101 in the index management device 100 executes the processing program 105 to realize functions of an update search module 111, an update-frequency determination module 112, a frequency-information report module 113, a frequency-information reception module 114, a frequency-information search module 115, a range management determination module 116, a distributed-management determination module 117, and a delegation control module 118. The memory 102 in the index management device 100 stores update-search count information 510, the index information 500, and the frequency-information database 520.

[Type of Index Management Device]

Each of the index management devices 100, 120, 140, and 160 in the present embodiment connects to the database system 10.

Types of index management device in the database system 10 include a representative management device that collectively manages the frequency information of the index information managed by the individual index management devices and a delegation-target management device that manages the index information whose management is delegated from another index management device. In the present embodiment, the index management device 100 is assumed to be a representative management device.

[Representative Management Device]

The representative management device obtains an update frequency for each index entry in order to collectively manage index entries having high update frequencies. The representative management device is autonomously selected and determined out of all index management devices in the database system 10. The representative management device can be set by specifying one of the index management devices in the database system 10 so as to execute processing for changing the index-information management ranges of the index management devices in addition to general processing for managing the index information. Instead of one index management device in the database system 10 executing the processing, multiple index management devices may sequentially execute the processing for managing the index management devices. For example, a scheme for setting the representative management device for each attribute item in the database may be employed.

When the index-entry management range is specified with a hash value, the representative management device can also specify the range by using the hash value. For example, the representative management device for aggregating the index information regarding the attribute item “temperature” may be an index management device having a management range including hash values for the “temperature”. The representative management device aggregates, for example, search frequencies and update frequencies of index information with respect to predetermined attribute information.

The representative management device determines a numeric range of the index entries in the index information managed by each index management device (the numeric range will hereinafter be referred to as a “management range”). On the basis of the determined management ranges and the number of index management devices, the representative management device determines management ranges of the individual index management devices so that the index management devices execute search processing by equal amounts and assigns the management ranges to the index management devices. When another index management device is added to the database system 10, the above-described processing makes it possible to assign the management ranges so that the amount of load of the added index management device is equal to the amount of load of each of the other index management devices. When an index management device is removed from the database system 10, it is also possible to assign the management ranges so that the amounts of load of the index management devices that remain after the removal are equal to each other. When multiple representative management devices exist, the management range may be divided into multiple ranges so that the index management devices take charge of corresponding assigned parts in the management ranges.

By executing the processing program 105, the processor 101 in the representative management device realizes functions described below, in addition to the functions of the index management device. When the index management device 100 is a representative management device, it has a function for receiving the index-information frequency information from other index management devices connected to the database system 10, a function for determining whether to maintain, combine, or divide the index entry (or index entries) in the index information on the basis of the received index-information frequency information, and a function for determining an index management device for managing the index entry (or index entries) to be combined or divided.

[Processing of Index Management Device]

Next, a description will be given of processing for detecting the frequency of search or update of each index entry. Each index management device in the database system 10 executes processing for detecting the frequency of search or update of each index entry in the index information. A description will now be given of processing executed by the index management device 100.

[Update Processing of Index Information]

The index management devices 100, 120, 140, and 160 update the index information in accordance with update requests received from the database devices 200 and 220.

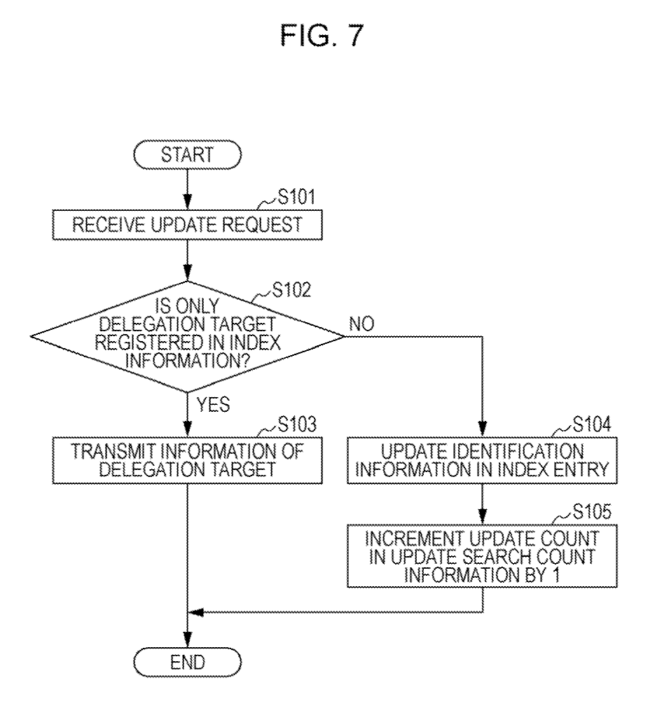

First, a description will be given of index-information update processing executed by each index management device. FIG. 7 is a flowchart of index-information update processing executed by each index management device. Each of the index management devices 100, 120, 140, and 160 in the database system 10 stores the number of updates (hereinafter referred to as an “update count”) of each index entry managed by the index management device.

First, the sensor 301 detects an attribute value. The database device 200 obtains identification information 251 of the sensor 301, an attribute value 254 detected by the sensor 301, and an attribute item 253 corresponding to the attribute value 254 detected by the sensor 301. The database device 200 updates the database 250 on the basis of the identification information 251, the attribute value 254, and the attribute item 253. The database device 200 updates the data in the database 250 by executing processing for deleting an attribute value 254 stored in an entry identified by the identification information 251 and the attribute item 253 in the database 250 and processing for registering the new attribute value 254 in the entry identified by the identification information 251 and the attribute item 253 in the database 250. The database device 200 can also update the data by executing processing for merely overwriting the entry, identified by the identification information 251 and the attribute item 253 in the database 250, with the new attribute value 254.

When the database device 200 updates the attribute value 254 in the entry identified by the identification information 251 and the attribute item 253 in the database 250, the attribute value 254 of the attribute item 253 corresponding to the identification information 251 changes. The database device 200 transmits, to the index management device 100, an index-information update request with respect to the change in the attribute value 254 of the attribute item 253, the attribute value 254 corresponding to the identification information 251. The update request includes conditions, for example, identification information to be updated, a pre-change attribute item and attribute value, a post-change attribute item and attribute value, and information of an index management device that manages an index entry. The conditions are, for example, an attribute value “33°” for the attribute item “temperature”, an attribute value “32°, 33°, 34°” for the attribute item “temperature”, and an attribute value “32°, 33°, 34°” for the attribute item “temperature and an attribute value “Office A” for the attribute item “place”. For example, when the update request has information of an index management device that manages an index entry, the database device 200 transmits the update request to the index management device. For example, when the update request does not have information of an index management device that manages an index entry, the database device 200 transmits the update request to an appropriate index management device.

In step S101, the update search module 111 in the index management device 100 receives an index-information update request from the database device 200. In step S102, the update search module 111 determines whether or not an index entry included in the update request is managed by collective management (in which multiple attribute values are collectively managed) or distributed management (in which multiple index entries resulting from division of a collectively managed index entry are managed) and is also associated with only information regarding the delegation-target management device.

When an index entry that is managed by the collective management or the distributed management and that has only information of the delegation-target management device is to be updated (Yes in step S102), the process proceeds to step S103 in which the update search module 111 transmits, to the request-source database device 200, the information related to the delegation-target management device and associated with the index entry. By obtaining the information related to the delegation-target management device, the database device 200 can identify the correct index management device to which the update request is to be transmitted. The information related to the delegation-target management device may be the delegation-target attribute-specifying information 504 corresponding to the index entry 501 containing the identification information or may be an identifier (e.g., an IP address/a port number) of the delegation-target management device. When an index management device that has received the update request does not have index information to be updated, the index management device may also transfer the update request to another index management device for managing the index information by identifying the index management device.

On the other hand, when an index entry having information other than the information of a delegation-target management device is to be updated (No in step S102), the process proceeds to step S104 in which the update search module 111 updates the index entry in the index information in the index management device 100 in accordance with the received update request.

When the index management device 100 manages an index entry 501 including a pre-update attribute value 254 and an index entry 501 including a post-update attribute value 254, the following processing is performed. The index management device 100 deletes, from the identification information 503 corresponding to the index entry 501 for the pre-update attribute value 254, the identification information for which the update request was issued. The index management device 100 also registers the identification information 251 in the identification information 503 that corresponds to the index entry 501 in the index information 500 and that corresponds to the post-update attribute value 254.

On the other hand, when the index management device 100 manages an index entry 501 containing a pre-update attribute value 254 and the index management device 120 manages an index entry 501 having a post-update attribute value 254, communication occurs between the index management device 100 and the index management device 120 during the update. For example, the index management device 100 and the index management device 120 update the index information 500 in the following procedure. First, the index management device 100 executes processing for searching for the index entry 501 having the pre-update attribute value 254 and deleting, from the identification information 503, the identification information for which the update request was issued. The index management device 100 then transmits, to the index management device 120, a notification indicating that the identification information for which the update request was issued was deleted. The index management device 120 then searches for the index entry 501 having the post-update attribute value 254 and registering the identification information in the identification information 503. Thus, when the index management device that manages a pre-update attribute value and the index management device that manages a post-update attribute value are different from each other, communication is occurred between the index management devices. When the attribute values change frequently, it is necessary to frequently perform the update processing. Thus, communication resulting from the update of the index information occurs frequently to thereby squeeze a communication bandwidth of the database system 10. This results in a decrease in the processing capability of the database system 10.

The update search module 111 increments, in the update-search count information 510, the update count of an updated index entry by 1. In the present embodiment, the update search module 111 increments each of the update count of a pre-update record and the update count of a post-update record by 1. In step S105, it is also possible to increase only the update count of a pre-update index entry or a post-update index entry by 1.

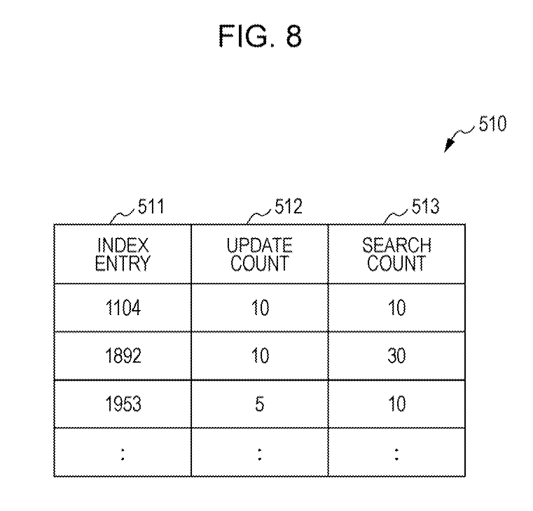

FIG. 8 illustrates an example of the update-search count information 510. Each of the index management devices 100, 120, 140, and 160 has the update-search count information 510 with respect to the index entries managed by the index management device. The update-search count information 510 has index entries 511, update counts 512, and search counts 513. The index entry 511 is an area that stores information corresponding to the index entry 501 in the index information 500. The update count 512 is an area that stores the number of times the update request is processed, i.e., update counts. The search count 513 is an area that stores the number of times the search request is processed, i.e., search counts.

[Search Processing of Index Information]

A description will now be given of processing for searching of the index information 500, the processing being executed by the update search module 111 in each of the index management devices 100, 120, 140, and 160. Now, a description will be given of processing executed by the index management device 100. The update search module 111 executes the processing upon receiving a request for searching the index information 500.

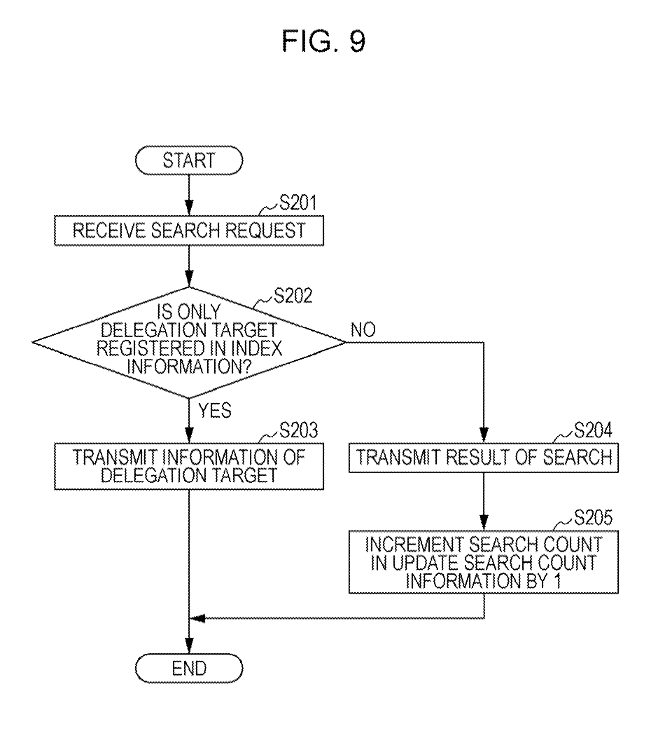

FIG. 9 is a flowchart of processing for searching the index information. The terminal 401 transmits a search request to the index management device 100. The search request includes the attribute item 253 and the attribute value 254 to be searched for by the request. Conditions included in the search request are, for example, an attribute value 254 “33°” for the attribute item 253 “temperature”, an attribute value 254 “32°, 33°, 34°” for the attribute item 253 “temperature”, and an attribute value 254 “32°, 33°, 34°” for the attribute item 253 “temperature” and an attribute value 254 “Office A” for the attribute item 253 “place”.

In step S201, the index management device 100 receives the search request from the terminal 401. In step S202, the update search module 111 determines whether or not an index entry included in the search request is managed by the collective management (in which multiple attribute values are collectively managed) or the distributed management (in which multiple index entries resulting from division of a collectively managed index entry are managed) and is also associated with only information related to a delegation-target management device.

When an index entry that is managed by the collective management or the distributed management and that has only information of the delegation-target management device is to be searched for (Yes in step S202), the process proceeds to step S203 in which the update search module 111 transmits, to the terminal 401 that is the search-requesting source, the information related to the delegation-target management device and associated with the index entry 501.

The update search module 111 transmits, to the terminal 401 that is the search-requesting source, the information related to the delegation-target management device and associated with the index entry 501. By obtaining the information related to the delegation-target management device, the terminal 401 can identify the correct index management device to which the search request is to be transmitted. The information related to the delegation-target management device may be the delegation-target attribute-specifying information 504 corresponding to the index entry 501 containing the identification information for which the search request is issued or may be an identifier (e.g., an IP address/a port number) of the delegation-target management device. By obtaining the information related to the delegation-target management device, the terminal 401 can identify the correct index management device to which the search request is to be transmitted. When the index management device that has received the search request does not have index information to be searched, the index management device may also transfer the search request to another index management device for managing the index information by identifying the index management device.

On the other hand, when an index entry having information other than the information of a delegation-target management device is to be searched for (No in step S202), the process proceeds to step S204 in which the update search module 111 searches the index entries 501 in the index information 500 in the index management device 100. The update search module 111 transmits the result of the search to the terminal that is the search-request transmitting source. In this case, processing for obtaining actual data corresponding to the located identification information from the database device may be performed by the terminal or may be performed by the index management device. The update search module 111 can also obtain; from the database 250, the attribute information 252 associated with the identification information 251 and can perform processing for determining whether or not the attribute information 252 matches the search condition in the search request. For example, when the index entry is managed in the attribute-value range (the temperature=30°±1°) and the search request indicates an individual value (the temperature=31°) included in the range, the update search module 111 can locate identification information that matches the search request by obtaining, from the database 250, the attribute information 252 associated with the identification information 251. In step S205, the update search module 111 increments, in the update-search count information 510, the search count 513 of the index entry searched for by 1.

[Update-Frequency Determination Processing]

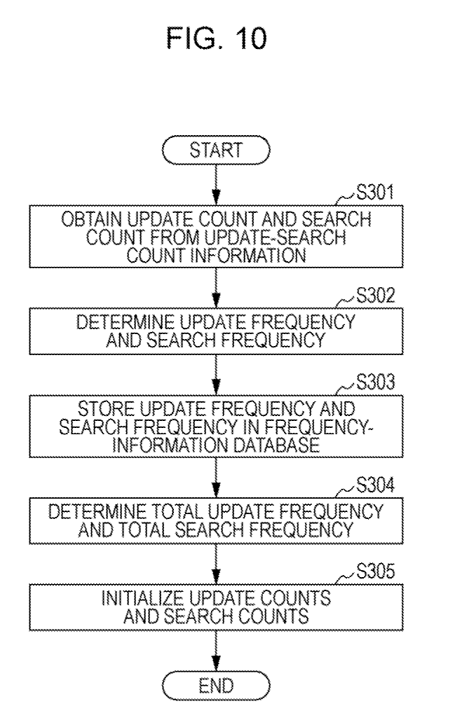

Next, a description will be given of processing for determining an update frequency for each index entry 501 in the index information 500. FIG. 10 is a flowchart of processing for determining the update frequency. A description below will be given in conjunction with an example of the index management device 100. The update-frequency determination module 112 in the index management device 100 determines the frequency information on the basis of the update-search count information 510 managed by the index management device 100 at a predetermined time interval (execution interval). The frequency information may include both the update frequency and the search frequency, only the update frequency, or only the search frequency. A designer pre-specifies the predetermined time interval on the basis of the performance of the index management devices in the database system 10, the search counts, the update counts, and so on. The predetermined time interval is, for example, 10 seconds. The update-frequency determination module 112 can also determine a frequency when the number of processing operations performed by the index management device 100 in response to the search requests or the update requests is smaller than a predetermined number, i.e., when the amount of load of the processing performed by the index management device 100 is small.

In step S301, the update-frequency determination module 112 reads, from the update-search count information 510, the update count 512 and the search count 513 for each index entry 511. In step S302, the update-frequency determination module 112 determines the update frequency and the search frequency for each index entry 511, for example, by dividing the update count 512 and the search count 513 by the execution interval, respectively. In step S303, the update-frequency determination module 112 stores the determined update frequency and search frequency in the frequency-information database 520.

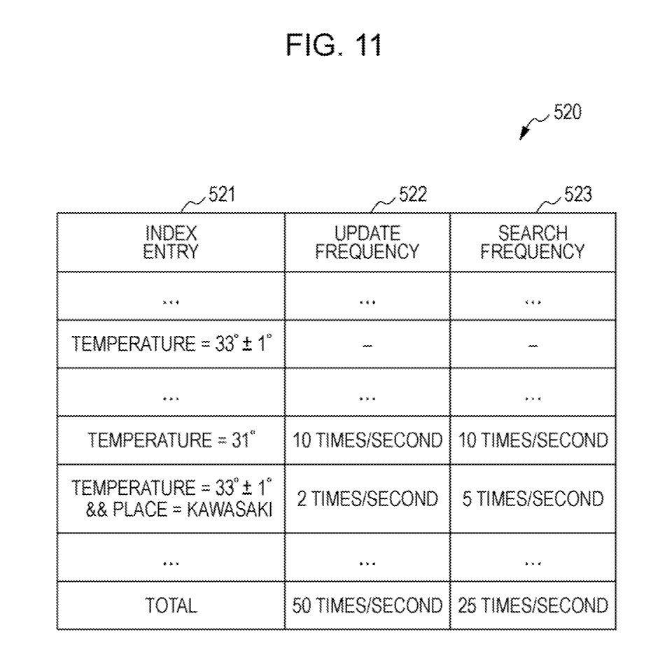

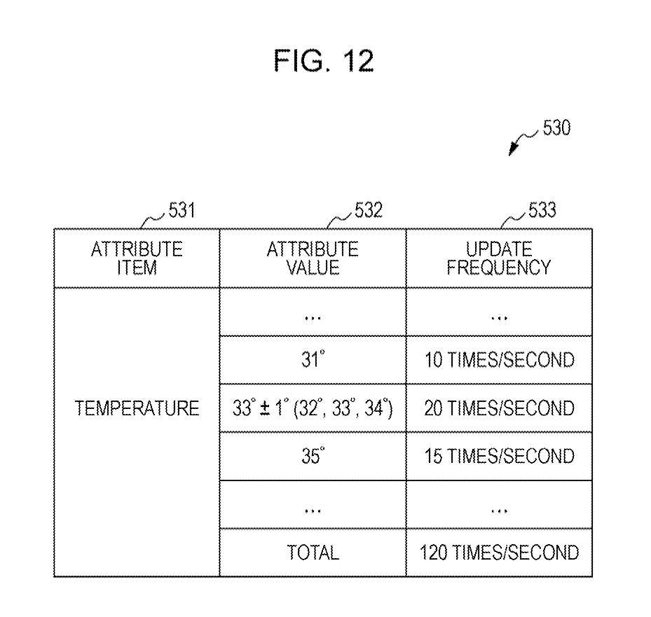

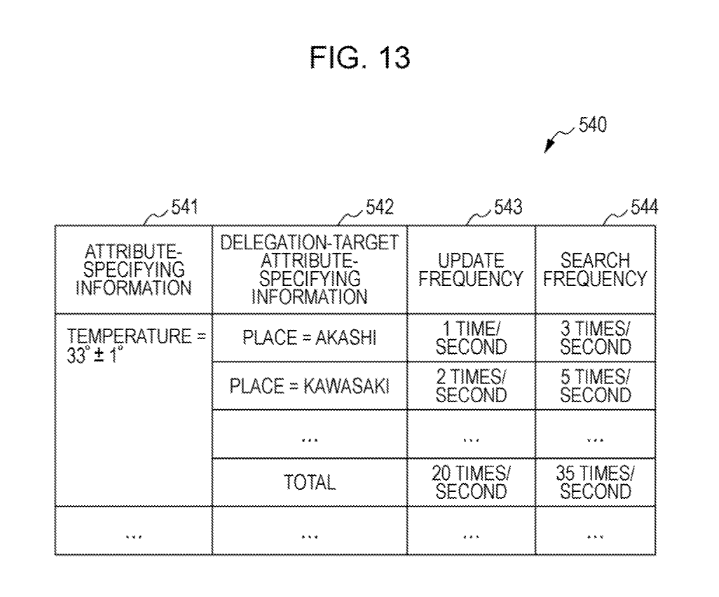

A description will now be given of management of the frequency information. The database system 10 according to the present embodiment manages the frequency information by using three types of database. The three types of database are the frequency-information database 520, a representative frequency-information database 530, and a delegation frequency-information database 540. The frequency-information database 520 is a database that stores the search frequencies and the update frequencies for the respective index entries managed by the index management device. FIG. 11 illustrates an example of the frequency-information database 520. The frequency-information database 520 has index entries 521, update frequencies 522, and search frequencies 523. The frequency-information database 520 is a database that stores the search frequencies and the update frequencies for the respective index entries to be managed, the index entries being received from the index management device to be managed by the representative management device. With respect to an index entry whose management is delegated to another index management device for the distributed management, the update-frequency determination module 112 in the present embodiment does not store the update frequency 522 and the search frequency 523 in the frequency-information database 520. The update-frequency determination module 112 manages, in the delegation frequency-information database 540, the index entry whose management is delegated to another index management device for the distributed management. FIG. 12 illustrates an example of the representative frequency-information database 530. The representative frequency-information database 530 has an attribute item 531 managed by the representative management device, attribute values 532 for the attribute item 531, and the update frequencies 533 of the attribute values 532. The delegation frequency-information database 540 is a database that manages the update frequencies and the search frequencies in the delegation targets when the distributed management is applied. FIG. 13 illustrates an example of the delegation frequency-information database 540. The delegation frequency-information database 540 has attribute-specifying information 541 of index entries whose managements are delegated, a delegation-target attribute-specifying information 542 indicating a delegation-target to which management of divided pieces of attribute-specifying information 541 is delegated, update frequencies 543 in the index entries in the delegation-targets identified by the delegation-target attribute-specifying information 542, and search frequencies 544 in index entries in the delegation targets identified by the delegation-target attribute-specifying information 542.

In step S304, the update-frequency determination module 112 determines an update frequency and a search frequency in the entire image processing system 100 by summing the update frequencies 522 and the search frequencies 523 of all the index entries 521 in the frequency-information database 520. After determining the update frequency and the search frequency, in step S305, the update-frequency determination module 112 initializes the update counts 512 and the search counts 513 in the update-search count information 510.

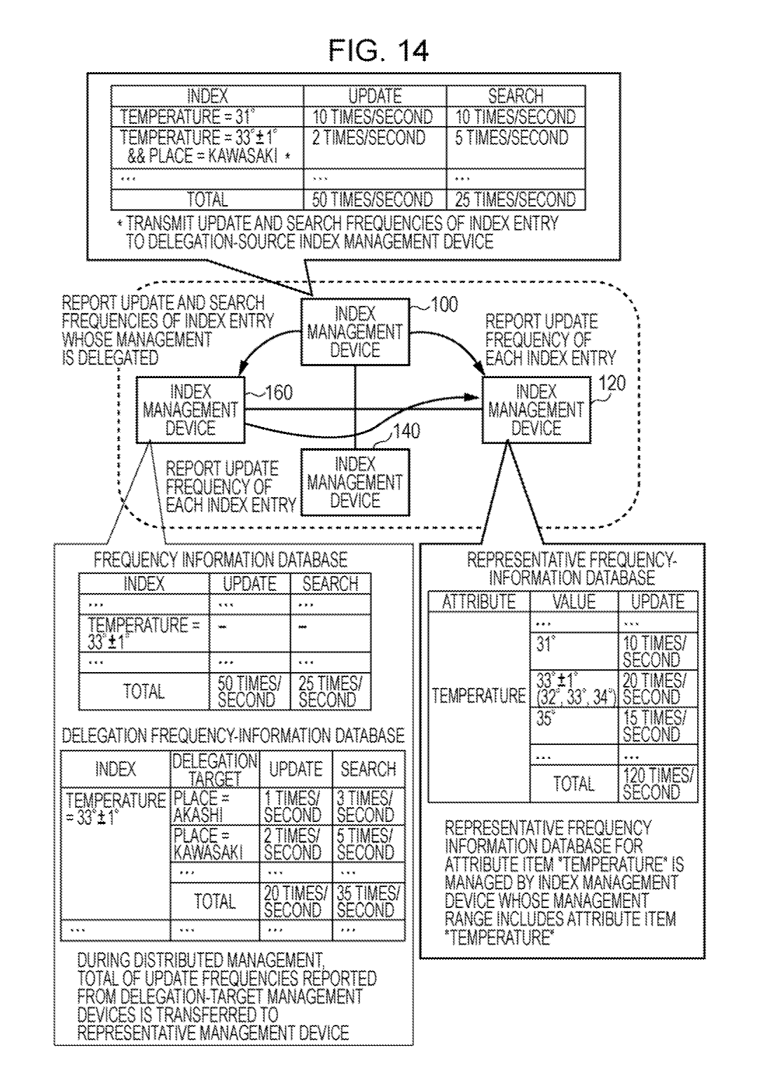

FIG. 14 illustrates an example of a state in which the index management devices manage the frequency information. The representative management device for the attribute item “temperature” is assumed to be the index management device 120. It is also assumed that the index management device 160 delegates the management of the index entry “Temperature=(32, 33, 34) and Place=Kawasaki” to the index management device 100. The index management device 100 transmits the frequency information of the index entry “Temperature=(32, 33, 34) and Place=Kawasaki” to the delegation-source index management device 160. The index management devices 100, 120, 140, and 160 transmit, to the index management device 120 serving as the representative management device, the frequency information of the index entries in the frequency information databases 520 managed by the corresponding index management devices.

[Frequency-Information Report Processing]

Next, a description will be given of frequency-information report processing performed by each index management device. The frequency-information report processing will be described in conjunction with an example of the frequency-information report module 113 in the index management device 100. In the description of the frequency-information report processing, the representative management device is assumed to be the index management device 120. The frequency-information report module 113 transmits, to the representative management device (i.e., the index management device 120), the update frequencies 522 and the search frequencies 523 in the frequency-information database 520 managed by the index management device 100.

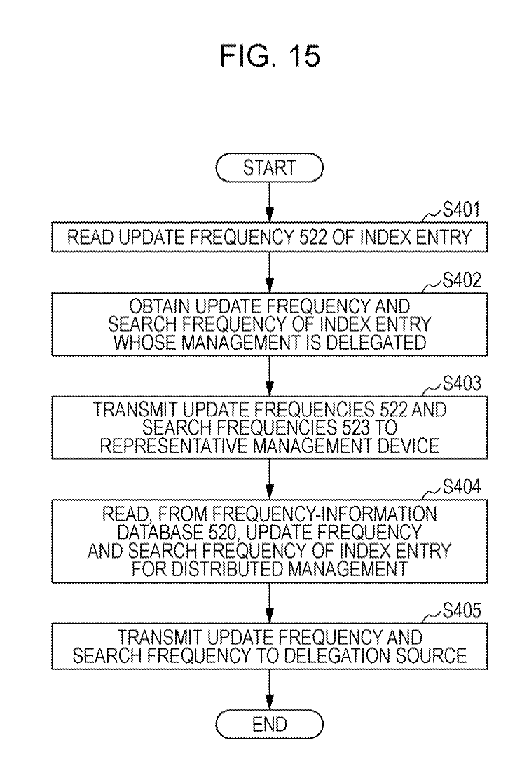

FIG. 15 is a flowchart of the frequency-information report processing.

In step S401, the frequency-information report module 113 reads the update frequency 522 of each index entry from the frequency-information database 520. In the present embodiment, the index entries 521 to be read by the frequency-information report module 113 do not include an index entry whose management is delegated to another index management device and an index entry whose management is delegated from another index management device.

In step S402, the frequency-information report module 113 obtains, from the frequency information database 520 included in the delegation-target index management devices, the update frequency and the search frequency of each index entry whose management is delegated. It is assumed that the index management device 100 manages the index entry 501 for the attribute-specifying information 502 “temperature=33±1”. It is also assumed that the index entry 501 for the attribute-specifying information 502 “temperature=33±1” is divided into two index entries and the managements thereof are delegated to the index management device 140 and the index management device 160. For example, one delegation-target management device (i.e., the index management device 140) manages the index entry for the attribute-specifying information “temperature=33±1 && place=Kawasaki Base” and another delegation-target management device (i.e., the index management device 160) manages the index entry for the attribute identification information “temperature=33±1 && place=Akashi Base”.

The frequency-information report module 113 sums the update frequencies and search frequencies of each of the two index entries obtained from the index management device 140 and the index management device 160. The frequency-information report module 113 stores the summed update frequency and the summed search frequency in the update frequency 543 and the search frequency 544 corresponding to the attribute-specifying information 541 “temperature=33±1” in the delegation frequency-information database 540.

In step S403, the frequency-information report module 113 transmits, to the representative management device (i.e., the index management device 120), the update frequencies 522 and the search frequencies 523 of the index entries managed by the index management device 100. When the representative management device is specified for each attribute item, the frequency-information report module 113 transmits the obtained update frequencies of the index entries to the representative management device that aggregates the update frequencies of the attribute item for each index entry.

In step S404, the frequency-information report module 113 reads, from the frequency-information database 520, the update frequency and the search frequency of each index entry whose management is delegated from another index management device by the distributed management. In step S405, the frequency-information report module 113 transmits, to the index management device that is the delegation source of the distributed management, the read update frequency and search frequency of the index entry.

[Frequency-Information Reception Processing]

Next, a description will be given of frequency-information reception processing. The frequency information may include both the update frequency and the search frequency, only the update frequency, or only the search frequency. The update-frequency reception processing will be described below in conjunction with an example in which the index management device 100 receives the frequency information from other index management devices. The frequency-information reception module 114 in the index management device 100 stores the frequency information for each index entry in the representative frequency-information database 530 or the delegation frequency-information database 540, the frequency information being received from the other index management devices 120, 140, and 160.

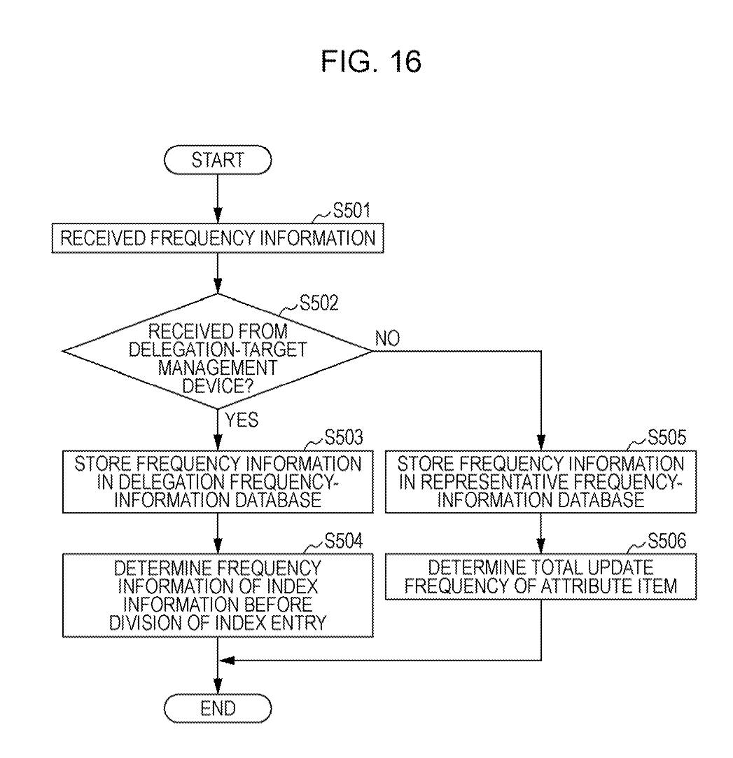

FIG. 16 is a flowchart of the frequency-information reception processing. In step S501, the frequency-information reception module 114 receives the frequency information of each index entry from the other index management devices 120, 140, and 160. In step S502, the frequency-information reception module 114 determines whether or not the frequency information is received from a delegation-target management device.

When the transmission source of the frequency information is a delegation-target management device (Yes in step S502), the process proceeds to step S503 in which the frequency-information reception module 114 stores the received frequency information in the update frequency 543 or the search frequency 544 in the delegation frequency-information database 540. In step S504, the frequency-information reception module 114 sums the frequency information of one index entry, the frequency information being received from multiple delegation-target management devices, to determine the index-information frequency information before the division of the index entry.

On the other hand, when the transmission source of the frequency information is not a delegation-target management device (No in step S502), the process proceeds to step S505 in which the frequency-information reception module 114 stores the received frequency information in the update frequency 533 in the representative frequency-information database 530. In step S506, the frequency-information reception module 114 determines a total update frequency of the attribute item by summing the index-entry update frequencies corresponding to the individual attribute values of the attribute item or the range of the attribute values. This processing is executed by only the representative management device that manages the representative frequency-information database 530.

[Frequency-Information Search Processing]

Next, a description will be given of frequency-information search processing. The frequency-information search processing will now be described in conjunction with an example of processing executed by the index management device 100. The frequency-information search module 115 in the index management device 100 searches for frequency information that matches a search request for attribute-specifying information, the search request being received from another index management device 120, 140, or 160, and issues a response to the search request. The frequency information may include both the update frequency and the search frequency, only the update frequency, or only the search frequency.

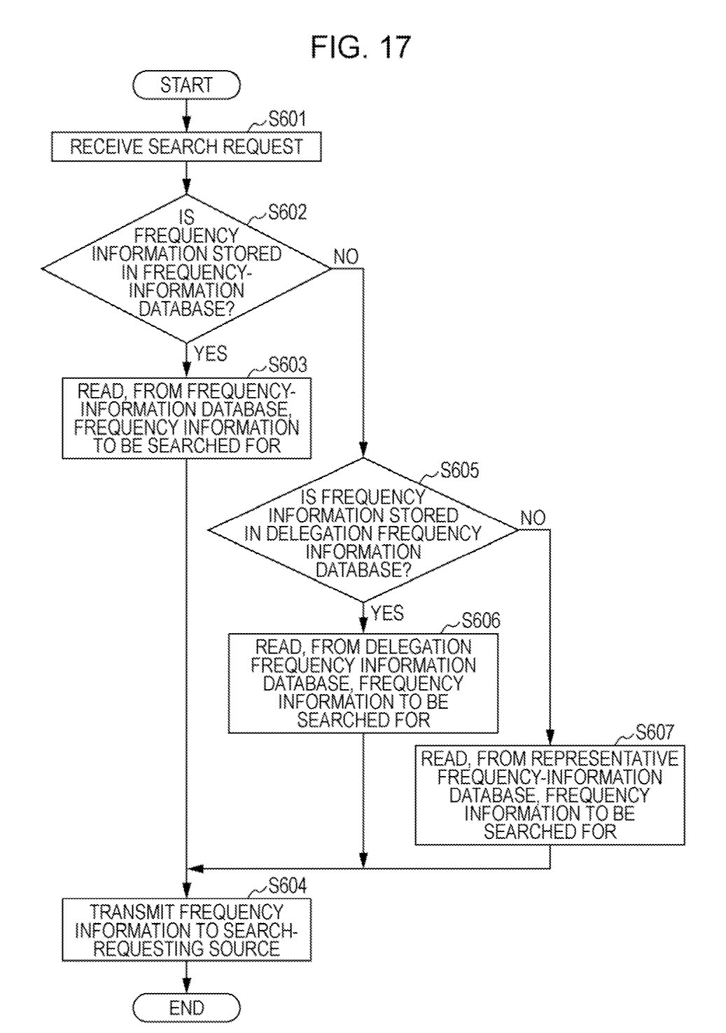

FIG. 17 is a flowchart of the frequency-information search processing. In step S601, the frequency-information search module 115 in the index management device 100 receives the frequency-information search request from another index management device 120, 140, or 160. The search request includes various types of search condition, for example, as follows:

(1) When an attribute item is a search condition so as to specify only the attribute item “temperature”, the search condition is “temperature”;

(2) When an attribute item and an attribute-value range are conditions so that the attribute item specifies “temperature” and the attribute value specifies the range of “32, 33, and 34”, the search condition is “temperature=(32, 33, 34)”; and

(3) When a combination of attribute items and attribute values is a search condition so that the attribute item specifies “temperature”, one attribute value of the attribute item “temperature” specifies the range of “32, 33, 34”, another attribute item specifies “place”, and the attribute value of the attribute item “place” specifies “Office A”, the search condition is “temperature=(32, 33, 34) && location=Office A”.

In step S602, the frequency-information search module 115 determines whether or not frequency information corresponding to the search condition is stored in the frequency-information database 520 in the index management device 100. When frequency information that matches the search condition is stored in the frequency-information database 520 in the index management device 100 (Yes in S602), the process proceeds to step S603 in which the frequency-information search module 115 reads, from the frequency-information database 520 in the index management device 100, the frequency information of the index entry that matches the search condition.

On the other hand, when frequency information that matches the search condition is not stored in the frequency-information database 520 in the index management device 100 (No in step S602), the process proceeds to step S605 in which the frequency-information search module 115 determines whether or not frequency information of an index entry corresponding to the search condition is stored in the delegation frequency-information database 540. When the frequency information that matches the search condition is stored in the delegation frequency-information database 540 (Yes in S605), the process proceeds to step S606 in which the frequency-information search module 115 reads, from the delegation frequency-information database 540, the frequency information that matches the search condition.

On the other hand, when frequency information that matches the search condition is not stored in the delegation frequency-information database 540 (No in step S605), the frequency-information search module 115 determines that frequency information that matches the search condition is stored in the representative frequency-information database 530. In step S607, the frequency-information search module 115 reads, from the representative frequency-information database 530, the update frequency of the index entry that matches the search condition. In step S604, the frequency-information search module 115 transmits the read frequency information to the index management device that is the search-requesting source.

[Range Management Determination Processing]

Next, a description will be given of processing for creating am index entry for collective management and processing for terminating the collective management on the basis of the update frequency of the index entry. A description below will be given of an example of processing performed by the index management device 100. The index management device 100 executes range management determination processing at each predetermined time interval. The representative management device may execute the range management determination processing.

The collective management is applied to the following cases. For example, it is assumed that the ambient temperature of a sensor for detecting temperature is easily variable in the range of 32° C., 33° C., and 34° C. In this case, the sensor can easily detect one of 32° C., 33° C., and 34° C. Thus, when the temperature detected by the sensor varies, the attribute value also changes and thus the index information changes. In this case, when the index management device that manages the attribute value “32° C.”, the index management device that manages the attribute value “33° C.”, and the index management device that manages the attribute value “34° C.” are different from each other, the index management devices perform data transmission/reception therebetween in order to update the index information. However, the communication for updating the index information is unwanted. That is, it is efficient to collectively manage the attribute values that change frequently by using one index management device.

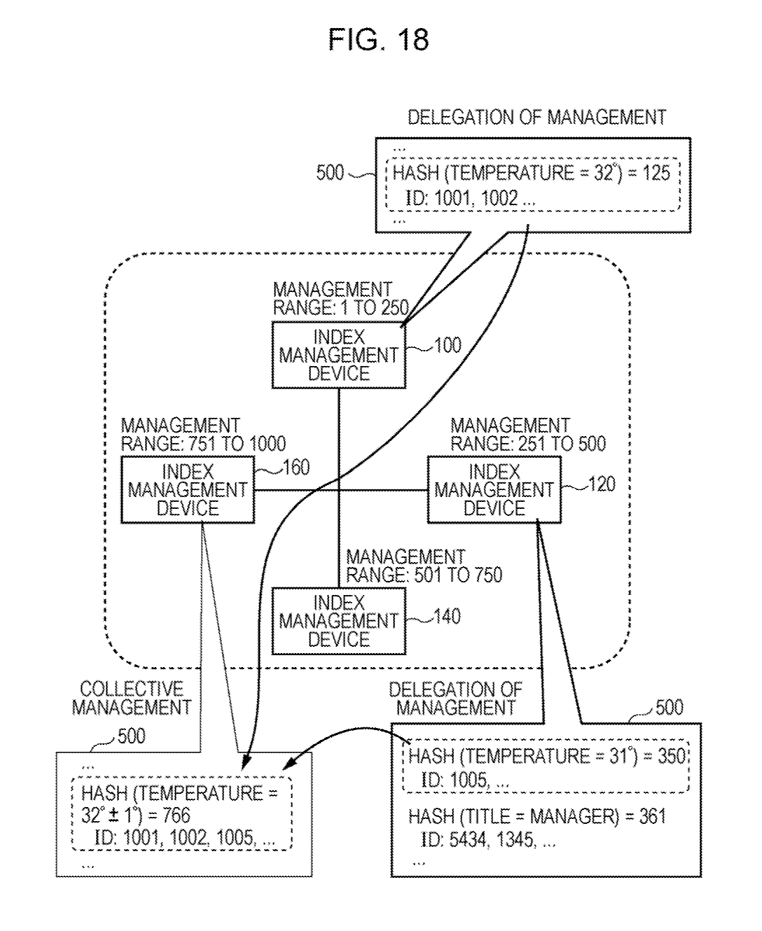

FIG. 18 illustrates an example of the collective management performed by the index management device. In FIG. 18, an index entry 501 “hash (temperature=32)” in the index information 500 managed by the index management device 100 is “125”. An index entry 501 “hash (temperature=31)” in the index information 500 managed by the index management device 120 is “350”. In this case, an index entry 501 that is a combination of the attribute values (temperature=31, 32, 33) of the attribute item “temperature” is created. The index entry 501 “hash (temperature=31, 32, 33)” of the created range is “766”. The index entry 501 “766” is managed by the index management device 160. Thus, the index management device 160 adds the index entry 501 “766” to the index information 500 in the index management device 160.

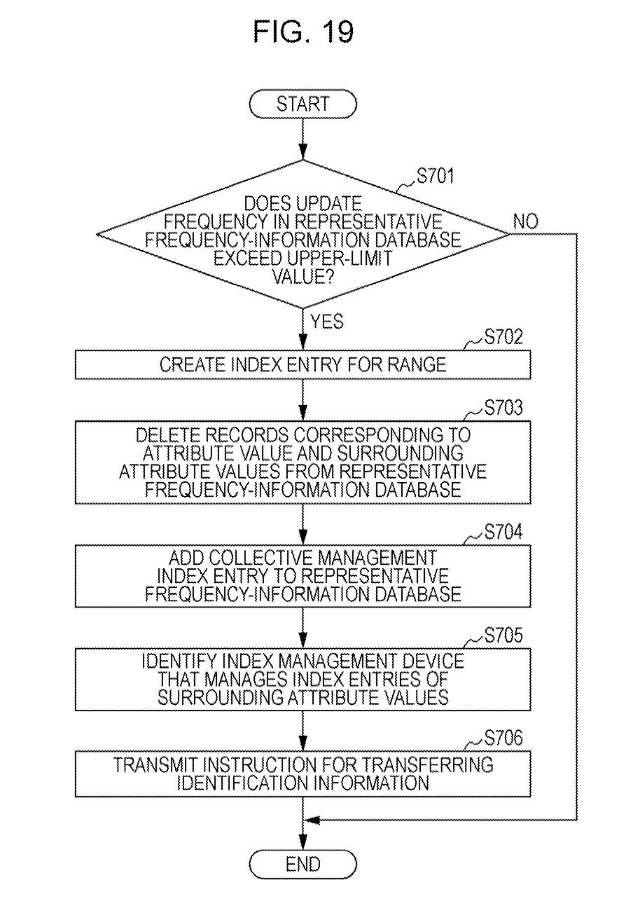

FIG. 19 is a flowchart of processing for determining index entries for the collective management on the basis of the frequency information.

In step S701, the range management determination module 116 determines whether or not the update frequency 533 in the representative frequency-information database 530 exceeds a predetermined value (an upper-limit value). The predetermined value (the upper-limit value) is pre-specified by the designer. The predetermined value (the upper-limit value) may be the same value for all attributes or may be varied for each attribute.

When the update frequency 533 that exceeds the upper-limit value exists (Yes in step S701), the process proceeds to step S702 in which the range management determination module 116 creates an index entry for a range including the attribute values (surrounding attribute values) around the attribute value of the index entry corresponding to the update frequency 533 exceeding the upper-limit value. In this case, the range management determination module 116 may create an index entry for a range by grouping surrounding attribute values including the attribute values at two opposite ends of the range of the attribute value corresponding to the update frequency 533 exceeding the upper-limit value into one range or by grouping more surrounding attribute values into one range. When multiple adjacent attribute values exceed the upper-limit value(s), the range management determination module 116 creates an index entry having a range including all the attribute values. A value obtained before or after a change in the attribute value is not necessarily a value around the attribute value. For example, when the attribute item is “place”, the attribute values “Office A” and “Office B” are not necessarily values that are adjacent to each other. In this case, the range management determination module 116 can also group index entries having high update frequencies into one range by combining the index entries. In step S703, the range management determination module 116 deletes, from the representative frequency-information database 530, records corresponding to the attribute value and the surrounding attribute values which were grouped in S702. In step S704, the range management determination module 116 adds, to the representative frequency-information database 530, the collective-management index entry that is constituted by the grouped attribute value and surrounding attribute values. Thereafter, the representative frequency-information database 530 can manage the update frequencies of the index entries corresponding to one attribute-value range (collective management) into which the attribute value and its surroundings were grouped. In the present embodiment, the index management device that manages the collectively managed index entry is assumed to be an index management device that manages attribute values corresponding to the update frequencies that exceed the upper-limit value. It is also possible to determine a hash value for the attribute-value range for the collective management and to determine an index management device for managing the hash value.

In step S705, the range management determination module 116 identifies an index management device that manages the index entries of the surrounding attribute values identified in step S702. In step S706, the range management determination module 116 transmits, to the index management device identified in step S705, an instruction for transferring the identification information included in the index entries of the surrounding attribute values to the index management device that collectively manages the range of the attribute values. As a result, the index management device that performs the collective management can obtain the identification information corresponding to the attribute values to be collectively managed.

When an index entry having an update frequency that exceeds the upper-limit value does not exist (No in step S701) or when the processing in step S706 is finished, the range management determination module 116 executes processing for terminating the collective management or dividing the range. When the number of update requests for the attribute-value range for which the collective management is applied becomes small, the database system 10 terminates the collective management. This is because responding to the search requests by using multiple index management devices, rather than responding to the search requests by using a single index management device, reduces the computational load for search per index management device. An entry to be subjected to the processing for the range division is only an index entry for the collective management.

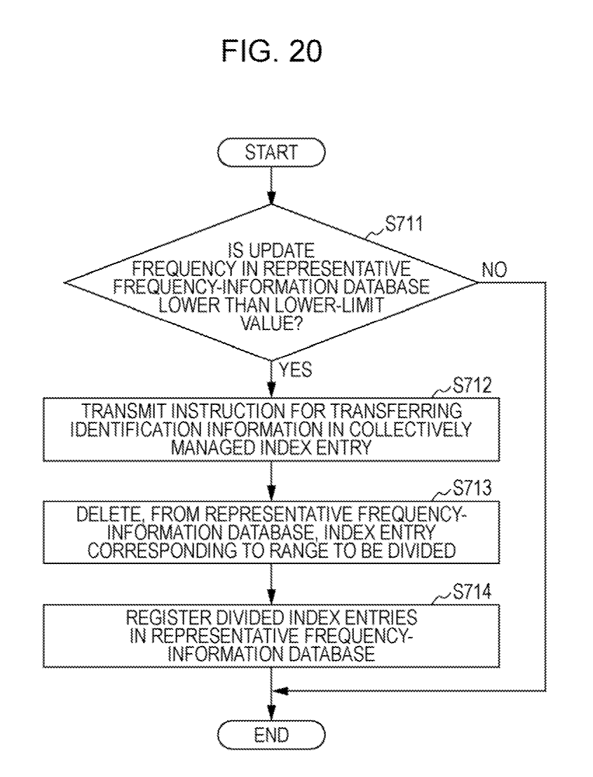

FIG. 20 is a flowchart of processing for terminating the collective management or dividing the range.

In step S711, the range management determination module 116 in the representative management device (the index management device 100) compares the update frequency 533 of the attribute value 532, collectively managed in the representative frequency-information database 530, with a predetermined value (a lower-limit value). The predetermined value (the lower-limit value) is pre-specified by the designer. The predetermined value (the lower-limit value) may be the same value for all attributes or may be varied for each attribute. The upper-limit value used in step S701 and the lower-limit value used in step S711 may be the same value or may be different values from each other.

Upon determining that an index entry having an update frequency that is lower than the lower-limit value (Yes in step S711), the range management determination module 116 returns the collectively managed index information to the index entries to be managed using the individual attribute values.

More specifically, in step S712, the range management determination module 116 transmits, to an index management device that manages index entries corresponding to the range of the collectively managed attribute values, an instruction for transferring the identification information included in the collectively managed index entry to the index management device that manages the index entries corresponding to the individual attribute values. The range management determination module 116 may decompose the identified range into individual attribute values of minimum granularity, may divide the identified range into multiple ranges, or may decompose the identified range into a range and individual attribute values. Decomposition of the range into individual values means, for example, decomposing an attribute-value range “temperature=33±2” into individual attribute values “temperature=31, 32, 33, 34, and 35”. Decomposition of the range into multiple ranges means, for example, decomposing a range “temperature=33±2” into a first range “temperature=32±1” and a second range “temperature=34 to 35”. Decomposition of the range into a range and individual attribute values means, for example, decomposing a range “temperature=33±2” into a range “temperature=32±1” and individual attribute values “temperature=34 and 35”. When distributed management is applied to the index information corresponding to the identified range, the range management determination module 116 divides the range after terminating the distributed management.

In step S713, the range management determination module 116 deletes, from the representative frequency-information database 530, the index entry corresponding to the range to be divided. In step S714, the range management determination module 116 registers, in the representative frequency-information database 530, divided index entries. Thus, the index management device 100 can manage the update frequencies of the divided index entries in the representative frequency-information database 530. Not only can the representative management device identify an attribute value having a high update frequency and an attribute value having a low update frequency on the basis of the aggregation result of the frequency information, but also each index management device can identify a value having a high update frequency and an attribute-value range having a low update frequency on the basis of the update frequencies of the index information managed by the corresponding index management device.

[Distributed Management Processing]

Next, a description will be given of distributed management processing in which index information that is collectively managed is divided for management in response to the amount of load involved in the index information management of the index management device. The term “distributed management” means that the index information to which collective management is applied is divided into multiple index entries on the basis of an attribute value having a low update frequency, so that the index entry managed by a single index management device for the collective management is managed by multiple index management devices. The application of the distributed management makes it possible to reduce the average load involved in the update and the search of the index information of all index management devices in the database system 10. The index management device can determine the load thereof by using various indices regarding loads, such as a CPU (central processing unit) utilization rate and the amount of memory consumed, involved in not only the update processing and search processing of the index information but also the management of the index information. In a state in which an index entry is divided into multiple index entries, when the condition for the attribute information during search of index information includes the multiple index entries, one terminal in the database system 10 can locate identification information that matches the condition by transmitting a search request to only one corresponding index management device. However, when the condition includes only one of the index entries, the terminal transmits a search request to multiple index management devices in order to locate identification information that matches the condition. As a result, the amount of time from when the terminal issues a search request until the result of the search is obtained may become larger after the distributed management is applied than before the distributed management is applied. Thus, when the distributed management is not applied, the efficiency of the search processing is higher. Accordingly, the index management device in the present embodiment uses the distributed management only when the collectively managed attribute value is frequently updated and searched for, and terminates the distributed management when the attribute value is not frequently updated and searched for. The index management device executes distributed-management determination processing each time a predetermined time interval (execution interval) is reached and when the amount of load of the processing of the index management device exceeds an allowable range. A description below will be given of an example of the processing of the index management device 100.

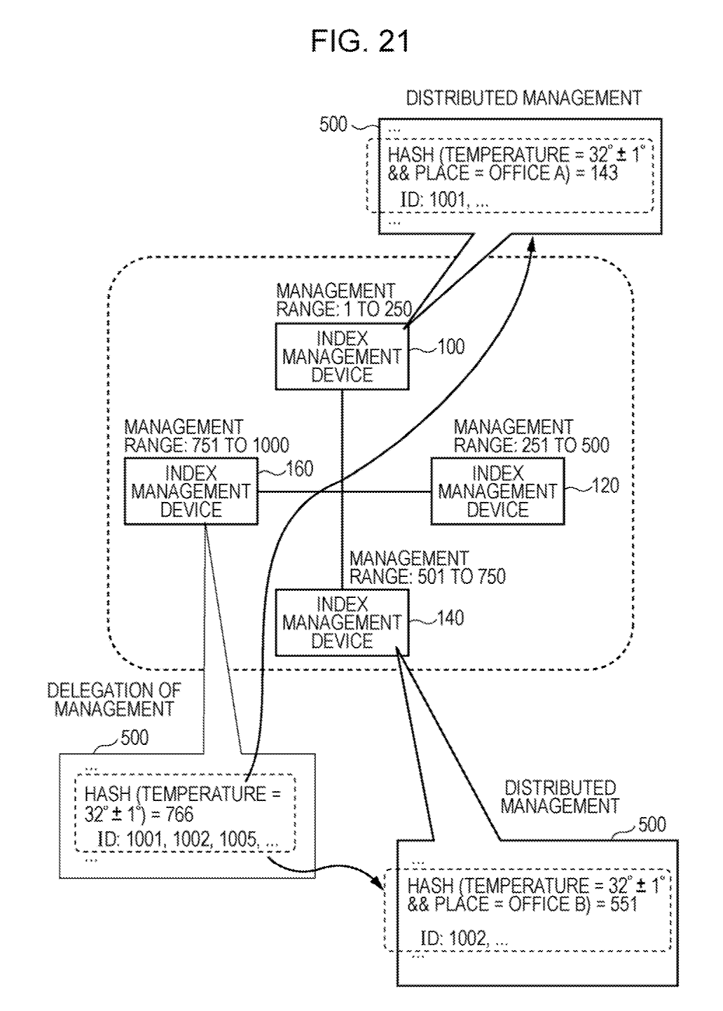

FIG. 21 illustrates an example of the distributed management performed by the index management devices. In FIG. 21, the index entry 501 “hash (temperature=31, 32, 33)” in the index information 500 managed by the index management device 160 is “766”. In this case, the index management device divides the index entry into an index entry having the attribute value “temperature=31, 32, 33” for the attribute item “temperature” and the attribute value “place=Office A” for the attribute item “place” and an index entry having the attribute value “temperature=31, 32, 33” for the attribute item “temperature” and the attribute value “place=Office B” for the attribute item “place”. The index management device 160 delegates the management of the divided index entries. The hash value for the attribute value “temperature=31, 32, 33” for the attribute item “temperature” and the attribute value “place=Office A” for the attribute item “place” is “143”. The index management device 100 that serves as a delegation-target management device adds the index entry 501 “143” to the index information 500. The hash value for the attribute value “temperature=31, 32, 33” for the attribute item “temperature” and the attribute value “place=Office B” for the attribute item “place” is “551”. The index management device 140 that serves as a delegation-target management device adds the index entry 501 “551” to the index information 500.

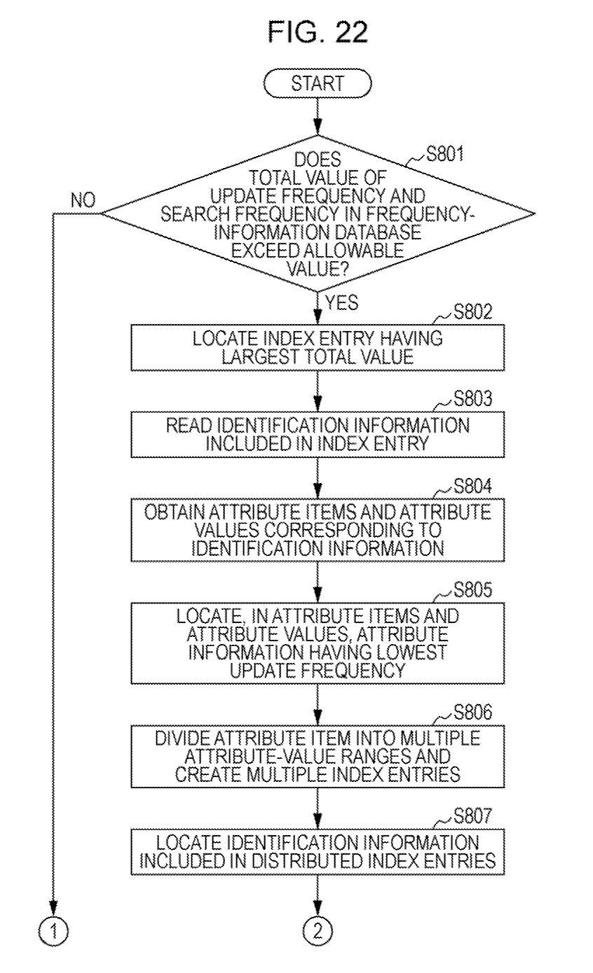

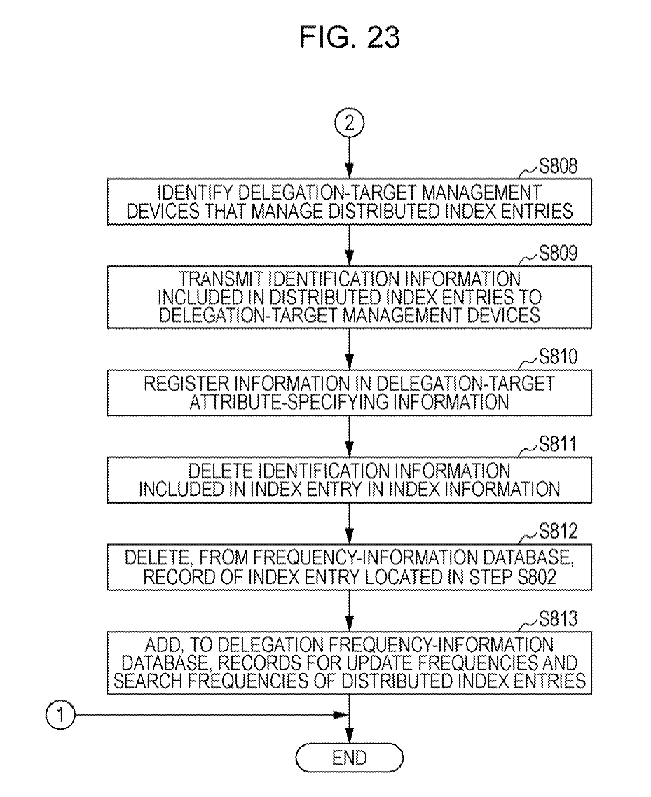

FIGS. 22 and 23 are flowcharts illustrating application of distributed management processing. In step S801, the distributed-management determination module 117 determines whether or not the total value of the update frequency and search frequency of each index entry contained in the frequency-information database 520 in the index management device 100 exceeds an allowable value. The allowable value is a numerically converted value of the amount of processing. For example, the amount of processing with which the processing time of the index management device 100 causes a problem with the operation of the database system 10 is set for the allowable value. The allowable value is, for example, pre-specified by the designer. The allowable value is set such that, for example, the total value of the update frequency or the search frequency is 100 (times/second) or less. The allowable value may be the same value for all index management devices or may be varied for each index management device on the basis of the performance thereof.

When the total value of the update frequency and search frequency of the index entry exceeds the allowable value (Yes in step S801), the distributed-management determination module 117 performs processing for applying the distributed management processing. On the other hand, when the total value of the update frequency and search frequency of the index entry does not exceed the allowable value (No in step S801), the distributed-management determination module 117 executes processing for terminating the distributed management processing. In the present embodiment, it is assumed that the total value of the update frequency and search frequency of the index entry “temperature=33±1” exceeds the allowable value”.

When the total value of the update frequency and search frequency of the index entry exceeds the allowable value (Yes in step S801), the process proceeds to step S802 in which the distributed-management determination module 117 locates, in the frequency-information database 520, the index entry 521 having a largest total value of the update frequency 522 and the search frequency 523. The distributed-management determination module 117 may locate, in the frequency-information database 520, information that most affects the load of the index information management processing of the index management device 100. With respect to an index entry which is already managed by the distributed management and whose management is delegated from another index management device, the distributed-management determination module 117 in the present embodiment does not execute the distributed management processing.

In step S803, the distributed-management determination module 117 reads the identification information 503 included in the index entry 501 in the index information 500 which corresponds to the index entry 521 located in step S802.

The distributed-management determination module 117 identifies a database management device that manages the identification information 503 read in step S803. In step S804, the distributed-management determination module 117 locates pieces of identification information 503 in the database 250 which correspond to the identification information 503 read in step S803 and obtains the attribute items 253 and the attribute values 254 corresponding to the located pieces of identification information 503. In this case, the distributed-management determination module 117 obtains the attribute items 253 and the attribute values 254 from all of the pieces of identification information 503 read in step S803.

More specifically, the distributed-management determination module 117 locates the attribute items 253 corresponding to the pieces of identification information 503 obtained in step S804. It is now assumed that the attribute items 253 corresponding to the identification information 503 are assumed to be “temperature”, “humidity”, and “place”. The distributed-management determination module 117 transmits a request for obtaining the update frequencies of the attribute items to the representative management device that manages the update frequencies of the located attribute items 253. In the present embodiment, the update frequency to be obtained by the request is a total value of update frequencies with respect to an individual attribute value and an attribute-value range. The distributed-management determination module 117 issues a request for obtaining the update frequencies of all the attribute items to the representative management device that manages the update frequencies of, for example, the attribute items “place” and “humidity”.

In step S805, the distributed-management determination module 117 locates, in the obtained attribute items 253 and attribute values 254, attribute information having a lowest update frequency. In this case, it is assumed that the attribute item “place” has the lowest update frequency. Selection of the attribute information having the lowest update frequency makes it possible to reduce the frequency of occurrence of communication, involved in the update of the attribute values, between the index management devices. The distributed-management determination module 117 may preferentially select an attribute item with which a large number of pieces of identification information are associated. This is because, for an attribute item with which a large number of pieces of identification information are associated, it is easy to divide the obtained identification into multiple index entries.

In step S806, the distributed-management determination module 117 divides the attribute item, located in step S805, into multiple attribute-value ranges and creates multiple index entries. For example, when the attribute item “place” is to be divided, the distributed-management determination module 117 divides the management range into the attribute value “Office A” and the attribute value “Office B”. Multiple index entries created by dividing a collectively managed index entry by distributed management processing are referred to as “distributed index entries”.

In step S807, the distributed-management determination module 117 locates the identification information included in the distributed index entries corresponding to the divided attribute-value ranges. For example, the distributed-management determination module 117 locates the identification information included in the attribute-value range “temperature=33±1 && place=Office A” and the identification information included in the attribute-value range “temperature=33±1 && place=Office B”.

In step S808, the range management determination module 117 identifies index management devices that manage the corresponding distributed index entries divided in step S806. The distributed-management determination module 117 computes, for example, a hash function “temperature=33±1 && place=Kawasaki Base” and a hash function “temperature=33±1 && place=Akashi Base” to determine hash values and identifies index management devices that include the hash values in their respective management ranges.

In step S808, the distributed-management determination module 117 can estimate whether or not the update and search frequencies in each delegation-target management device is within the allowable range. Since the managements of the distributed index entries are delegated to the delegation-target management devices only when the update and search frequencies in the delegation-target management devices are within the allowable range, it is possible to distribute the amount of load of the processing of the index management devices. More specifically, the distributed-management determination module 117 estimates update and search frequencies involved in the management of each distributed index entry on the basis of the number of pieces of identification information included in the divided distributed index entries. The distributed-management determination module 117 also obtains the update frequencies, search frequencies, and the allowable range in the delegation-target management devices for the divided distributed index entries. When it is determined that the delegation of the managements of the distributed index entries causes the update frequencies and search frequencies in the delegation-target management devices for the distributed index entries to exceed the allowable range, the distributed-management determination module 117 divides the identified attribute item into multiple ranges having attribute-value combinations that are different from the previous combinations. For example, the distributed-management determination module 117 finely divides the attribute-value range into, for example, “place=Room C in Office A”, “place=Room D in Office A”, “Meeting Room E in Office B”, and “Floor F in Office B”. Thereafter, the distributed-management determination module 117 re-executes the processing for identifying index management devices that manage the respective divided distributed index entries. When the attribute-value range is divided into a larger number of smaller ranges, a larger number of delegation-target management devices manage the distributed index entries and thus the amount of time for the search processing increases. Accordingly, the distributed-management determination module 117 changes the division regulation such that the number of pieces of index information after the division increases gradually.

In step S809, the distributed-management determination module 117 transmits, to the delegation-target management devices identified in step S808, the identification information included in the distributed index entries and located in step S807.

In step S810, the distributed-management determination module 117 registers, in the delegation-target attribute-specifying information 504 in the index information 500, information related to the delegation-target management devices. The information related to the index management devices may be attribute information corresponding to the distributed index entries containing the identification information or may be network identifiers (e.g., IP addresses and port numbers) of the index management devices.

In step S811, the distributed-management determination module 117 deletes the identification information 503 included in the index entry 501 in the index information 500 which correspond to the index entry 521 located in step S802.

In step S812, the distributed-management determination module 117 deletes, from the frequency-information database 520, the record corresponding to the index entry 521 located in S802.

In step S813, the distributed-management determination module 117 adds, to the delegation frequency-information database 540, records for managing the update frequencies and the search frequencies of the distributed index entries created in step S806. Thereafter, the index management device 100 that has delegated the managements of the index entries can manage, in the delegation frequency-information database 540, the update frequencies and search frequencies of the distributed index entries received from the delegation-target management devices identified in step S808.

[Termination of Distributed Index Entries]

Next, a description will be given of termination of the distributed index entries created by the distributed management processing. A description below will be given in conjunction with an example of the index management device 100. The index management device 100 periodically obtains the update frequencies and search frequencies of the distributed index entries from the delegation-target management devices. The index management device 100 determines whether or not the load of managing the index information is permissible even when the distributed index entries are returned to the original index information. When it is permissible, the index management device 100 obtains the identification information included in the distributed index entries from the delegation-target management devices for the distributed index entries and resumes the management of the pre-distributed management index entry.

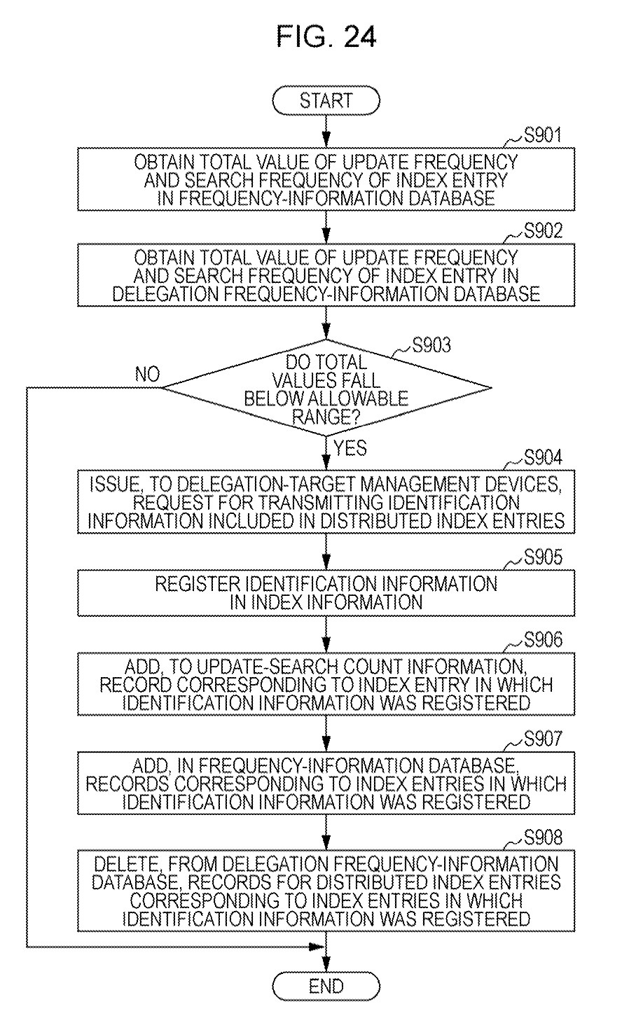

FIG. 24 is a flowchart of termination of the distributed management processing.

In step S901, the distributed-management determination module 117 in the index management device 100 obtains the total value of the update frequency and search frequency of each index entry contained in the frequency-information database 520.

In step S902, the distributed-management determination module 117 obtains the total value of the update frequency and search frequency of each index entry contained in the delegation frequency-information database 540. In step S903, the distributed-management determination module 117 determines whether or not the total values obtained in steps S901 and S902 fall below an allowable range. The distributed-management determination module 117 determines whether or not the load involved in the management of the index information can be dealt with even when the distributed management is terminated.

When the total values exceed the allowable range (No in step S903), the distributed-management determination module 117 ends the processing without terminating the distributed index entries. On the other hand, when the total values fall below the allowable range (Yes in step S903), the distributed-management determination module 117 performs distributed management termination processing in step S904 and subsequent steps. When multiple distributed index entries exist, the distributed-management determination module 117 does not need to simultaneously terminate the whole distributed management. The distributed-management determination module 117 may sequentially terminate the distributed management, first starting from index information having a smaller total value of the update frequency and the search frequency.

In step S904, the distributed-management determination module 117 issues, to the delegation-target management devices identified in step S808, a request for transmitting identification information included in the distributed index entries. In step S905, the distributed-management determination module 117 registers the received identification information in the identification information 503 in the index information 500. In step S906, the distributed-management determination module 117 adds, to the update-search count information 510, records corresponding to the index entries 501 in which the identification information 503 was registered in step S905. In step S907, the distributed-management determination module 117 adds, to the frequency-information database 520, records corresponding to the index entries 501 in which the identification information 503 was registered in step S905. In step S908, the distributed-management determination module 117 deletes, from the delegation frequency-information database 540 for the delegation-target management devices, records that manage the update frequencies and search frequencies of the distributed index entries corresponding to the index entries 501 in which the identification information 503 was registered in step S905.

[Transmission Processing of Identification Information]

Next, a description will be given of processing for transmitting the identification information, included in the index entry in the index information, to another index management device. A description below will be given in conjunction with an example of the index management device 100. The delegation control module 118 executes transmission processing upon receiving a request for transmitting the identification information 503 included in the index entry 501 registered in the index information 500. When the distributed management is applied or terminated, the delegation control module 118 transmits the identification information included in the index entry 501. The delegation control module 118 also updates the contents of the update-search count information 510 and the frequency-information database 520, the contents being associated with the index entry.

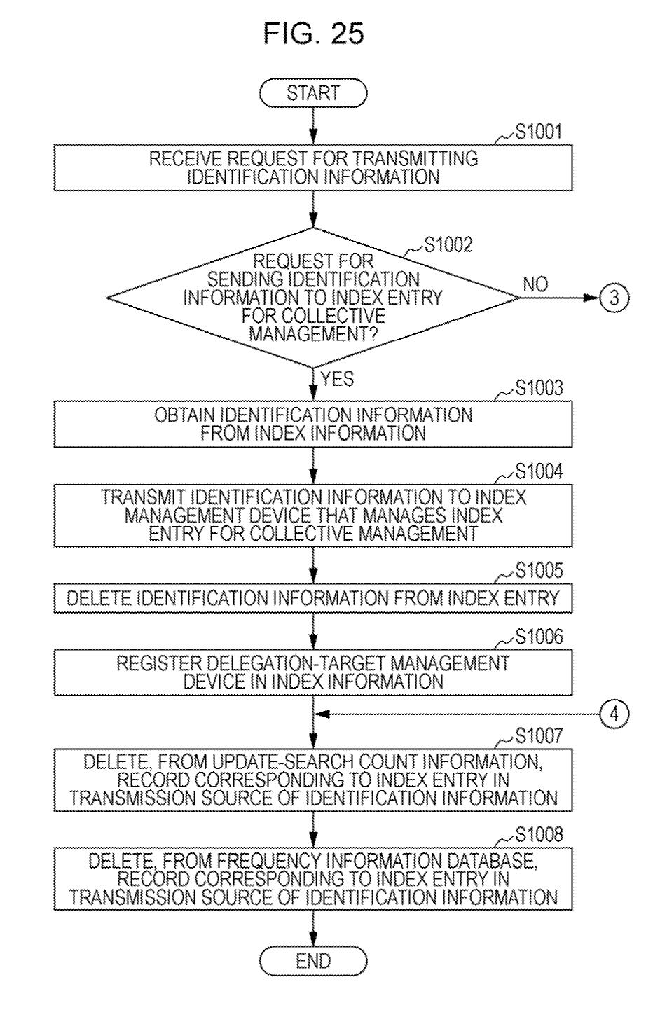

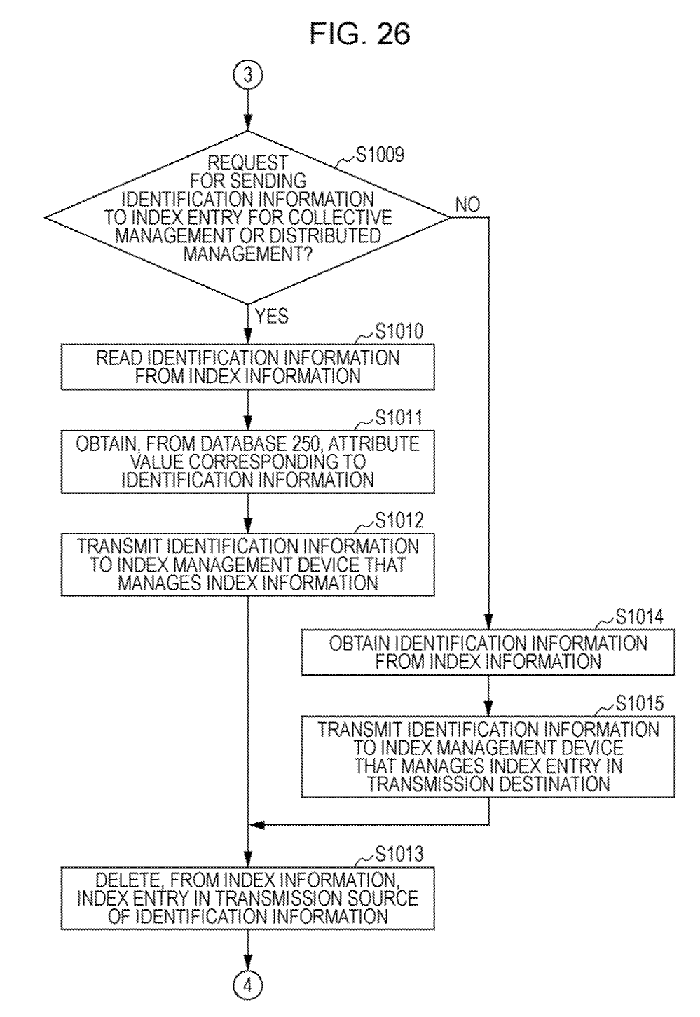

FIGS. 25 and 26 are flowcharts of the processing for transmitting the identification information.

In step S1001, the delegation control module 118 receives a request for transmitting the identification information 503 included in the index entry 501 registered in the index information 500. In step S1002, the delegation control module 118 determines whether or not the received request is a request for sending, to the index information corresponding to an attribute-value range, the identification information included in the index information corresponding to an attribute value or an attribute-value range. The attribute value of the attribute item “temperature” for the index entry in the transmission source is, for example, 33. The attribute value of the attribute item “temperature” for the index entry in the transmission destination is, for example, 33±1.

When the received request is a request for sending the index information to the index information corresponding to an attribute-value range (Yes in step S1002), the delegation control module 118 executes identification-information transmission processing involved in application of the range management.

In step S1003, in the identification-information transmission processing involved in application of the range management, the delegation control module 118 obtains, from the index information 500, the identification information included in the index entry in the index management device that is the transmission source of the identification information specified by the received request.

In step S1004, the delegation control module 118 transmits the identification information obtained in step S1003 to the index management device that manages the index entry including the identification information requested in step S1001.

In step S1005, the delegation control module 118 deletes the identification information from the index entry in the transmission source of the identification information requested in step S1001.

In step S1006, the delegation control module 118 registers, in the index information 500, information related to the transmission destination of the identification information. The information related to the transmission destination of the identification information may be the delegation-target attribute-specifying information or may be an identifier (e.g., an IP address/a port number) of the index management device.

When the received request is not a request for sending the identification information to the index information corresponding to an attribute-value range (No in step S1002), the process proceeds to step S1009 in which the delegation control module 118 determines whether or not the received request is a request for sending, to an index entry corresponding to an individual attribute value or divided attribute-value ranges, the identification information included in the index entry corresponding to the attribute-value range.

When the received request is a request for transmitting the identification information to an index entry corresponding to an individual attribute value or divided attribute-value ranges (Yes in step S1009), the delegation control module 118 executes identification-information transmission processing involved in termination of the range management.

In step S1010, the delegation control module 118 reads, from the index information, the identification information included in the index entry in the transmission source of the identification information specified by the request received in step S1001. The index entry in the transmission source of the identification information specified by the request corresponds to the attribute-value range.

In step S1011, the delegation control module 118 searches the database 250 to obtain an attribute value corresponding to the identification information obtained in step S1010. Consequently, the delegation control module 118 can identify the index entry to which each piece of the identification information is to be sent.

In step S1012, the delegation control module 118 transmits, to the index management device that manages the index information located in step S1010, the identification information included in the index entry in the transmission source of the identification information specified by the request received in step S1001.

On the other hand, when the received request is not a request for sending the identification information to an index entry corresponding to an individual attribute value or divided attribute-value ranges (No in step S1009), the delegation control module 118 performs identification-information transmission processing involved in distributed management termination in step S1014 and subsequent steps. In step S1014, the delegation control module 118 obtains, from the index information, the identification information included in the index entry in the transmission source of the identification information specified by the request received in step S1001. In step S1015, the delegation control module 118 transmits the identification information obtained in step S1014 to the index management device that manages the index entry (the index entry before the distributed management) in the transmission destination of the identification information specified by the request received in step S1001.

After the processing in step S1012 or S1015, in step S1013, the delegation control module 118 deletes, from the index information, the index entry in the transmission source of the identification information.

After the processing in step S1013 or S1006, in step S1007, the delegation control module 118 deletes, from the update-search count information 510, a record corresponding to the index entry in the transmission source of the identification information. In step S1008, the delegation control module 118 deletes, from the frequency-information database 520, a record corresponding to the index entry in the transmission source of the identification information.

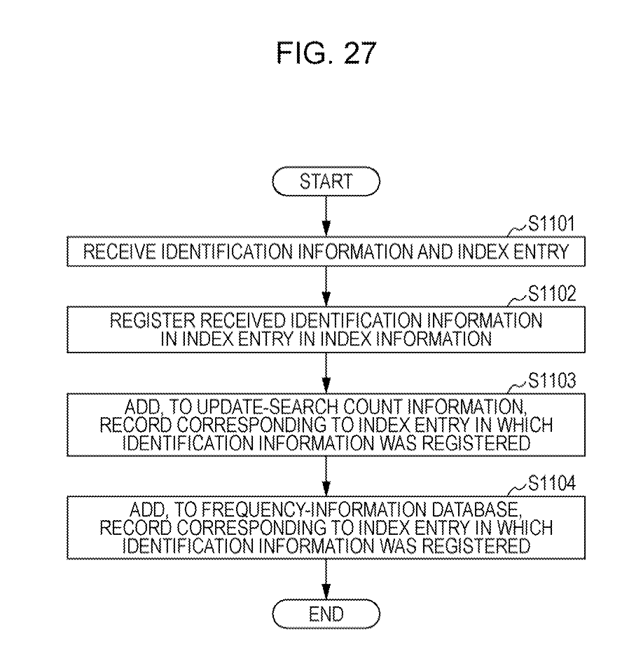

Next, a description will be given of processing for receiving the identification information transmitted from another index management device and registering the received identification information in the index information. FIG. 27 is a flowchart of processing for receiving the identification information. The delegation control module 118 in the index management device 100 starts the processing upon receiving the identification information from another index management device. In step S1101, the delegation control module 118 receives the identification information and also receives information of the index entry in which the identification information is to be registered. In step S1102, the delegation control module 118 registers the identification information, received in step S1101, in the index entry 501 that is included in the index information 500 and that corresponds to the index entry received in step S1101. In step S1103, the delegation control module 118 adds, to the update-search count information 510, a record corresponding to the index entry 501 in which the identification information 503 was registered in step S1102. In step S1104, the delegation control module 118 adds, in the frequency-information database 520, a record corresponding to the index entry 501 in which the identification information was registered in step S1102.

With the arrangement described above, the database system 10 can efficiently manage the index information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A management device of a database system including a database device for managing a database including data records, each of the data records including identification information for identifying the data records and an attribute value, a plurality of index devices for managing an index database including index records, each of the index records including search condition information and the identification information, the search condition information being determined by the attribute value, each of the plurality of index devices managing each of parts of the index database, the management device comprising:
a receiver for receiving an update of the attribute value from the database device; and
a processor for executing a process including:
detecting a frequency of update of the attribute value stored in the database device,
generating search condition information by combining the attribute values, each of the attribute values having the frequency of update higher than a predetermined frequency,
generating the index record including the generated search condition information and the identification information associated with one of the combined attribute values included in the generated search condition information, and
determining one of the plurality of index devices for managing the generated index record.

2. The management device according to claim 1, wherein the data records including a plurality of data items.

3. The management device according to claim 2, wherein the process of the generating of the search condition information generates the search condition information by combining the attribute values associated with same data item.

4. The management device according to claim 1, wherein the process includes transmitting a request for stopping managing the index record which is combined to the generated index record to one of the plurality of index devices managing the index record.

5. The management device according to claim 1, wherein the process of the generating of the search condition information generates the search condition information by combining the attribute values including the attribute values at two opposite ends of the range of the attribute value having the frequency of the update higher than a predetermined frequency.

6. The management device according to claim 1, wherein the process includes dividing the generated index record when the frequency of the update of the attribute value of the generated index record is lower than a second predetermined frequency.

7. The management device according to claim 1, wherein the process includes detecting the attribute value having the frequency of the update higher than a third predetermined frequency, specifying the attribute value having the frequency of the update lower than a fourth predetermined value among the attribute values included in the generated index record, and dividing the generated index record by the specified attribute value.

8. The management device according to claim 1, further comprising a plurality of sensors identified by the identification information, wherein the database device receives attribute value from the plurality of sensors, updates the received attribute value, and sends the update of the attribute value to the plurality of index devices.

9. A method of controlling a database system including a database device for managing a database including data records, each of the data records including identification information for identifying the data records and an attribute value, and a plurality of index devices for managing an index database including index records, each of the index records including search condition information and the identification information, the search condition information being determined by the attribute value, each of the plurality of index devices managing each of parts of the index database, the method comprising:
detecting a frequency of update of the attribute value stored in the database device,
generating search condition information by combining the attribute values, each of the attribute values having the frequency of update higher than a predetermined frequency,
generating the index record including the generated search condition information and the identification information associated with one of the combined attribute values included in the generated search condition information, and
determining one of the plurality of index devices for managing the generated index record.

10. The method according to claim 9, wherein the data records including a plurality of data items, and wherein the generating of the search condition information generates the search condition information by combining the attribute values which are associated with same data item.

11. The method according to claim 9, further comprising transmitting a request for stopping managing the index record which is combined to the generated index record to one of the plurality of index devices managing the index record.

12. The method according to claim 9, wherein the generating of the search condition information generates the search condition information by combining the attribute values including the attribute values at two opposite ends of the range of the attribute value having the frequency of the update higher than a predetermined frequency.

13. The method according to claim 9, further comprising dividing the generated index record when the frequency of the update of the attribute value of the generated index record is lower than a second predetermined frequency.

14. The method according to claim 9, further comprising detecting attribute value that has update frequencies higher than a third predetermined frequency, specifying the attribute value having the frequency of the update lower than a fourth predetermined value among the attribute values included in the generated index record, and dividing the generated index record by the specified attribute value.

15. A database system comprising:
a database device for managing a database including data records, each of the data records including identification information for identifying the data records and an attribute value;
a plurality of index devices for managing an index database including index records, each of the index records including search condition information and the identification information, the search condition information being determined by the attribute value, each of the plurality of index devices managing each of parts of the index database; and
a management device executing a process including:
detecting a frequency of update of the attribute value stored in the database device,
generating search condition information by combining the attribute values, each of the attribute values having the frequency of update higher than a predetermined frequency,
generating the index record including the generated search condition information and the identification information associated with one of the combined attribute values included in the generated search condition information, and
determining one of the plurality of index devices for managing the generated index record.
